(19) United States
(12) Patent Application Publication
(10) Pub. No.: US 2021/0284362 A1
(43) Pub. Date: Sep. 16, 2021

(54) CONTROL SYSTEMS, APPRATUS, AND METHODS FOR USE WITH THRUSTERS

(71) Applicant: Prince Mohammad Bin Fahd University, Dhahran (SA)

(72) Inventors: Wael AL-KOUZ, Amman (JO); Nassim KHALED, Covington, GA (US)

(73) Assignee: Prince Mohammad Bin Fahd University, Dhahran (SA)

(21) Appl. No.: 16/814,345

(22) Filed: Mar. 10, 2020

(51) Int. Cl. B64G 1/40; B64G 1/58; B64G 1/66; B64G 1/26

(52) U.S. Cl. CPC B64G 1/405; B64G 1/26; B64G 1/66; B64G 1/58

(57) ABSTRACT

Control systems, apparatus, and methods for use with thrusters are disclosed. A disclosed propulsion system includes a PPT including circuitry configured to generate plasma from a propellant and a magnetic field that propels the plasma away from the PPT in an expulsion direction. The propulsion system also includes a sensor including a laser receiver and a laser transmitter that are positioned on the PPT. The laser receiver is configured to receive a signal from the laser transmitter. The propulsion system also includes a controller connected to the circuitry and the sensor. In response to the plasma interrupting the signal, the controller is configured to detect an observed parameter of the plasma via the sensor, calculate an observed thrust efficiency of the PPT based on the observed parameter, and modulate, via the circuitry, the magnetic field to maintain the observed thrust efficiency at a target thrust efficiency of the PPT.

### BACKGROUND

### Field of the Disclosure

This disclosure relates generally to thrusters and, more particularly, to control systems, apparatus, and methods for use with thrusters.

### Background

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Aerospace vehicles typically employ electric thrusters and automated systems or controllers capable of improving performance (e.g., relating to efficiency, velocity, impulse, etc.) of the thrusters. For example, a satellite may include a pulsed plasma thruster (PPT) configured to provide thrust to the satellite. Certain controllers may be communicatively coupled to sensors of such a thruster to periodically measure characteristics associated with the thruster by receiving sensor data from the sensors. These controllers can implement complex algorithms or equations relating to dynamic control theory (e.g., proportional-integral-derivative (PID) control theory) to process the sensor data. The controllers may facilitate control of onboard systems of the thruster based on the processed sensor data by generating a control signal and transmitting the signal to operable control assemblies of the thruster. In recent years, these automated controllers have become more complex with advancements of more powerful processor architectures and continue to incorporate applications of control theory that previously were not feasible.

### SUMMARY

An aspect of the present disclosure includes a propulsion system. The propulsion system includes a PPT including circuitry, an anode, a cathode, and a propellant arranged between the anode and the cathode. The circuitry is configured to generate (a) plasma from the propellant via an ignition member of the PPT and (b) a magnetic field, via the anode and the cathode, that propels the plasma away from the PPT in an expulsion direction. The propulsion system also includes a sensor including a laser receiver and a laser transmitter that are positioned on the PPT. The laser receiver is configured to receive a signal from the laser transmitter. The propulsion system also includes a controller connected to the circuitry and the sensor. In response to the plasma interrupting the signal, the controller is configured to detect an observed parameter of the plasma via the sensor, calculate an observed thrust efficiency of the PPT based on the observed parameter, and modulate, via the circuitry, the magnetic field to maintain the observed thrust efficiency at a target thrust efficiency of the PPT.

Another aspect of the present disclosure includes an apparatus for a thruster. The apparatus includes a sensor positioned on the thruster proximate to an exhaust port of the thruster. The apparatus also includes a controller operatively coupled to the thruster and configured to detect an observed parameter of a plasma generated by the thruster via the sensor. The plasma is to be expelled from the exhaust port. The controller is also configured to calculate an observed thrust efficiency of the thruster based on the observed parameter. The controller is also configured to modulate, via circuitry of the thruster, a magnetic field propelling the plasma away from the thruster in an expulsion direction to maintain the observed thrust efficiency at a target thrust efficiency of the thruster.

Another aspect of the present disclosure includes a computer-implemented method of providing thrust. The computer-implemented method includes controlling circuitry of a thruster to generate (a) plasma from a propellant via an ignition member and (b) a magnetic field, via an anode and a cathode, that propels the plasma away from the thruster in an expulsion direction. The computer-implemented method also includes detecting an observed parameter of the plasma via a sensor positioned proximate to an exhaust port. The computer-implemented method also includes calculating an observed thrust efficiency of the thruster based on the observed parameter. The method also includes modulating, via the circuitry, the magnetic field to maintain the observed thrust efficiency at a target thrust efficiency of the thruster.

The foregoing paragraphs have been provided by way of general introduction, and are not intended to limit the scope of the following claims.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates a schematic diagram of an example propulsion system in which examples disclosed herein can be implemented;

FIG. 2 illustrates a schematic diagram of an example control loop of the example propulsion system of FIG. 1 in accordance with the teachings of this disclosure;

FIGS. 3A and 3B are graphs illustrating different operating characteristics of an example thruster in accordance with the teachings of this disclosure;

FIGS. 4A and 4B are graphs illustrating different operating characteristics of an example thruster in accordance with the teachings of this disclosure;

FIGS. 5A and 5B are graphs illustrating different operating characteristics of an example thruster in accordance with the teachings of this disclosure;

FIG. 6 is a block diagram of an example control system in accordance with the teachings of this disclosure;

FIG. 7 is a flowchart representative of an example method that can be executed to implement the example control system of FIG. 6 to provide propulsion to a body or mass;

FIG. 8 is a flowchart representative of an example method that may be executed to implement the example control system of FIG. 6 to detect one or more observed parameters of propelled plasma;

FIGS. 9 and 10 are flowcharts representative of example methods that may be executed to implement the example control system of FIG. 6 to modulate a magnetic field generated by an example thruster to maintain an observed efficiency at a target efficiency; and

FIG. 11 is a block diagram of an example processor platform structured to execute instructions to carry out the methods of FIGS. 7-10 and/or, more generally, to implement the control system of FIG. 6.

The figures are not to scale. In general, the same reference numbers will be used throughout the drawing(s) and accompanying written description to refer to the same or like parts.

### DETAILED DESCRIPTION

Some electric thrusters, such as PPTs, have controllers configured to automatically control thruster functions. However, these controllers may fail to sufficiently maintain one or more optimal operating parameters during operation of the electric thrusters. Typically, such a controller controls an electric thruster to provide a substantially constant magnetic field for propelling plasma generated by the electric thruster. That is, the strength of the magnetic field does not substantially change over time as the electric thruster generates thrust. As a result, plasma velocity associated with the electric thruster generally decreases over time and, consequently, thrust efficiency of the electric thruster decreases over time.

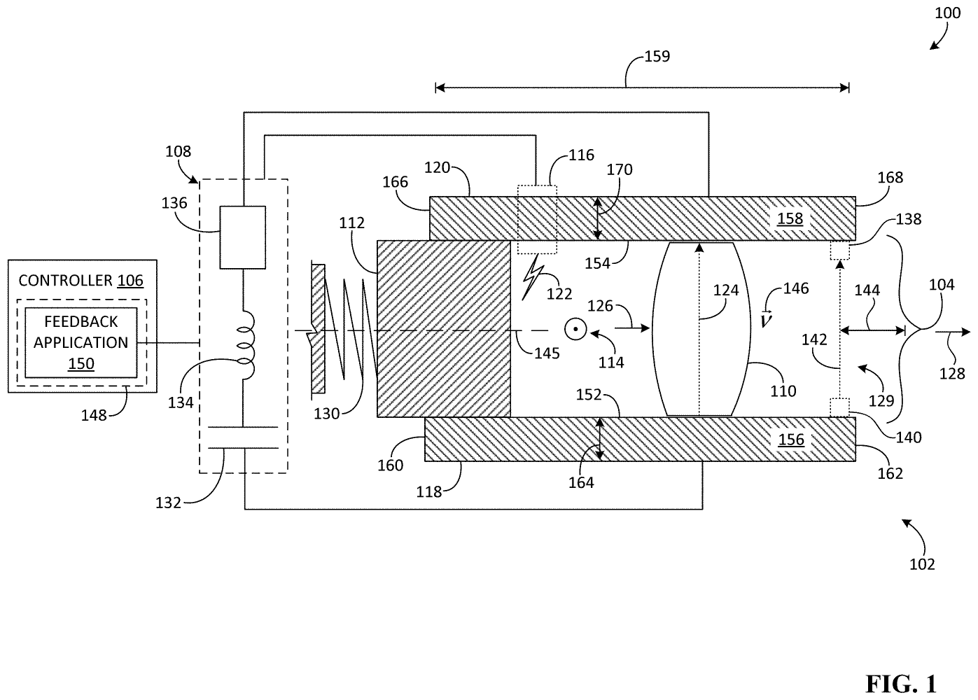

Control systems, apparatus, and methods for use with thrusters are disclosed. Disclosed examples provide an efficient, low mass, and low cost propulsion solution. Some disclosed examples provide an apparatus for a thruster such as, for example, a PPT configured to provide thrust to an aerospace vehicle (e.g., a satellite). The thruster includes a propellant (e.g., Teflon) and example circuitry configured to generate (a) plasma from the propellant and (b) a magnetic field that propels the plasma. The disclosed apparatus includes an example controller (e.g., a feedback controller) and one or more example sensors (e.g., a laser receiver and/or a laser transmitter) positioned on the thruster. The disclosed controller is connected to the sensor(s) and the circuitry of the thruster. As will be discussed in greater detail below in connection with FIGS. 1, 2, 3A, 3B, 4A, 4B, 5A, 5B, and 6-11, the disclosed controller controls the circuitry to modulate the magnetic field to maintain an observed thrust efficiency of the thruster at a predefined or target thrust efficiency (e.g., optimal thrust efficiency) of the thruster. In particular, the controller is configured to calculate the observed thrust efficiency of the thruster and advantageously utilize the observed or calculated thrust efficiency as feedback with which to modulate the magnetic field.

In some examples, the controller is configured to detect one or more observed parameters (e.g., one or more of an observed velocity, an observed mass, etc.) of the plasma via the sensor(s) as the plasma is ejected or expelled from the thruster. The controller is also configured to calculate the observed thrust efficiency based on the observed parameter(s) of the plasma, for example, via one or more related models and/or equations. In such examples, the controller can perform a comparison of the observed thrust efficiency with the target thrust efficiency and calculate, based on the comparison, one or more adjustments for the circuitry of the thruster associated with modulating the magnetic field. Then, the disclosed controller executes or carries out the adjustment(s). In particular, the controller is configured to adjust one or more electrical parameters of the circuitry based on the calculated adjustment(s), thereby controlling a magnitude or strength of the magnetic field. For example, the disclosed controller can adjust (a) an input voltage used in connection with charging a capacitor of the circuitry for a pulse of the thruster and/or (b) a magnitude or strength of an electric current discharged from the capacitor during the pulse. In this manner, examples disclosed herein rapidly compensate and/or correct undesired thrust efficiency of the thruster. As a result, examples disclosed herein improve efficiency as well as velocity of the thruster and, consequently, the impulse.

In some examples, the controller includes a feedback controller (e.g., a PID controller) forming a feedback control loop with the thruster and the sensor(s). In such examples, the disclosed controller employs one or more control strategies corresponding to any of (a) proportional feedback control, (b) integral feedback control, (c) derivative feedback control, (d) or a combination thereof. In such examples, the disclosed sensor(s) continuously or repeatedly obtain sensor data (e.g., raw sensor data) indicative of one more parameters associated with the thruster such as, for example, any of a plasma velocity, a plasma mass, the input voltage, a capacitance of the capacitor, etc. In such examples, the disclosed controller is configured to generate, based on the sensor data, feedback control commands to rapidly control the circuitry of the thruster or a particular circuit component (e.g., the capacitor) thereof. In particular, the circuitry of the thruster can generate the magnetic field based on the feedback control commands to provide rapid control, compensation, and/or correction with respect to reducing a calculated error value, which enables the thruster to achieve the target thrust efficiency. The calculated error value is determined by the controller and includes, for example, (a) a difference between the observed thrust efficiency and the target thrust efficiency and/or (b) a difference between an observed velocity of the plasma and a predefined or target velocity of the plasma. Further, the controller can update (e.g., continuously or repeatedly) the feedback control commands to enable the circuitry of the thruster to adjust or change the strength of the magnetic field based on changes of, for example, the observed thrust efficiency of the thruster, the observed velocity of the plasma, and/or any other characteristic or parameter associated with the thruster. In such examples, the controller may process subsequent sensor data received from the sensor(s) to determine whether and/or how to update the feedback control commands. In particular, a time varying strength of the magnetic field is facilitated by the controller and based on the subsequent sensor data.

Examples disclosed herein can be advantageously utilized in a wide-range of applications. For example, in aerospace applications, the disclosed controller and sensor(s) can be implemented in an aerospace vehicle, such as a satellite, to improve performance of one or more thrusters of the aerospace vehicle.

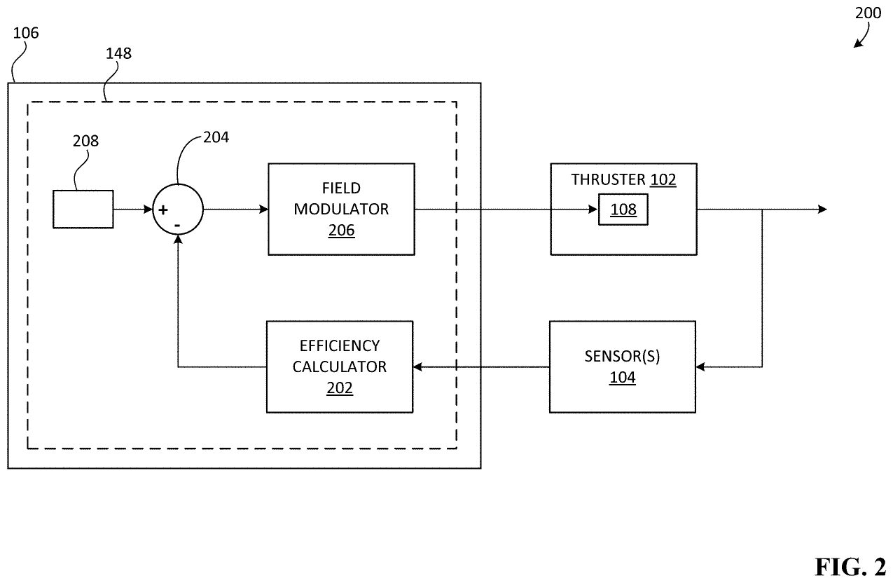

FIG. 1 illustrates a schematic diagram of an example propulsion system 100 in which examples disclosed herein can be implemented. According to the illustrated example of FIG. 1, the propulsion system 100 includes a thruster 102, one or more sensors 104, and a controller 106. The thruster 102 of FIG. 1 includes example circuitry 108 that is configured to generate plasma (e.g., a charged gas cloud) 110 from a propellant (e.g., Teflon) 112. The circuitry 108 of the thruster 102 is also configured to generate a magnetic field 114 that propels the plasma 110. The controller 106 of FIG. 1 is connected to the circuitry 108 and the sensor(s) 104. In particular, to improve performance of the thruster 102, the controller 106 is configured to control, based on data generated by the sensor(s) 104, the circuitry 108 to modulate the magnetic field 114 during operation of the thruster 102, which will be discussed in greater detail below in connection with FIGS. 2, 3A, 3B, 4A, 4B, 5A, 5B, and 6-11. In some examples, the controller 106 is configured to detect one or more observed parameters (e.g., an observed velocity) of the plasma 110 via the sensor(s) 104. Then, the controller 106 is configured to calculate an observed thrust efficiency of the thruster 102 based on the observed parameter(s). More particularly, in such examples, the controller 106 is also configured to modulate, via the circuitry 108, the magnetic field 114 to maintain the observed thrust efficiency at a predefined or target thrust efficiency (e.g., an optimal thrust efficiency) of the thruster 102.

The thruster 102 of FIG. 1 is configured to provide thrust to a body or mass such as, for example, an aerospace vehicle. In some examples, the thruster 102 can be implemented in a spacecraft (e.g., a satellite). According to the illustrated example of FIG. 1, the thruster 102 is an electric thruster such as, for example, a PPT. Additionally, the thruster 102 of FIG. 1 can include a housing coupled to and/or providing support to the components of the thruster as well as the controller 106 and sensor(s) 104.

To facilitate changing a state of the propellant 112, the thruster 102 can also include an example ignition member 116. The ignition member 116 of FIG. 1 can be coupled to part of the thruster 102 proximate to the propellant 112. The ignition member 116 can also be electrically connected to the circuitry 108 to receive one or more control signals or commands and/or electrical power from the circuitry 108, for example, via one or more transmission or signal wires extending from the circuitry 108 to the ignition member 116. In particular, the ignition member 116 is configured to generate an arc 122 of electricity that interacts with the propellant 112 to change a state of at least part of the propellant 112. Accordingly, the ignition member 116 of FIG. 1 can be advantageously controlled or operated by the circuitry 108 during operation of the thruster 102. For example, the circuitry 108 is configured to generate the plasma 110 from the propellant 112 via the ignition member 116.

Additionally, to facilitate propelling the plasma 110, the thruster 102 can also include a first conductor (e.g., an electrode such as an anode or cathode) 118 and a second conductor (e.g., an electrode such as an anode or cathode) 120. As shown in FIG. 1, the propellant 112 can be arranged between the first and second conductors 118, 120 and adjacent the ignition member 116. For example, the first and second conductors 118, 120 of FIG. 1 form a chamber or cavity in which the propellant 112 is disposed. In particular, the first and second conductors 118, 120, together, are configured to draw electrical energy stored by the circuitry 108 to generate the magnetic field 114. For example, the first conductor 118 of FIG. 1 is transmitting an electric current (e.g., a high-current pulse) 124 from the circuitry 108 to the second conductor 120 via the plasma 110. That is, in the illustrated example of FIG. 1, the electric current 124 is flowing through the plasma 110 from the first conductor 118 to the second conductor 120. As such, the first conductor 118 is sometimes referred to as a cathode, and the second conductor 120 is sometimes referred to as an anode. On the other hand, if a direction of the electric current 124 is switched (i.e., the electric current 124 flows through the plasma 110 from the second conductor 120 to the first conductor 118), the first conductor 118 is sometimes referred to as an anode, and the second conductor 120 is sometimes referred to as a cathode. More particularly, the magnetic field 114 of FIG. 1 is induced between the first and second conductors 118, 120 as a result of such electrical discharge associated with the circuitry 108. According to the illustrated example of FIG. 1, interaction of the magnetic field 114 and the electric current 124 generates a force (e.g., a Lorentz force) 126 that is applied to the plasma 110, which causes the plasma 110 to accelerate in a first direction (e.g., an expulsion direction) 128. As a result, the plasma 110 is ejected or expelled from the thruster 102, for example, at a relatively high velocity.

Each of the conductors 118, 120 can be implemented, for example, using a single plate (e.g., any of a flat plate, a bent plate, a curved plate, a tapered plate, etc.) or a plurality of plates. In particular, each of the conductors 118, 120 is constructed of one or more materials have suitable electrical properties (e.g., a relatively high conductivity) such as, for example, one or more metals, etc., any other suitable material(s), or a combination thereof. According to the illustrated example of FIG. 1, each of the first conductor 118 and the second conductor 120 is electrically connected to the circuitry 108, for example, via one or more signal or transmission wires extending from the circuitry 108 to the respective first and second conductors 118, 120.

In some examples, the first and second the conductors 118, 120 form and/or define a body (e.g., a tubular body) of the thruster 102 having any suitable shape. For example, the first and second conductors 118, 120 of FIG. 1 can define a cylindrical body. In such examples, each of the first and second conductors 118, 120 is semi-circular such that, when the first and second conductors 118, 120 are positioned adjacent each other or assembled, the first and second conductors 118, 120 provide the cylindrical body. However, the first conductor 118 of FIG. 1 and/or and second conductor 120 of FIG. 1 can be shaped differently such that, when assembled, the first and second conductors 118, 120 define, for example, any of a rectangular body, a square body, a triangular body, a conical body, etc. Additionally, the thruster 102 of FIG. 1 includes a port (e.g., an exhaust port) 129 from which the plasma 110 is expellable. That is, the plasma 110 of FIG. 1 is to be expelled from the port 129 during operation of the thruster 102. In some examples, the first and second conductors 118, 120 form and/or define the port 129 or at least a portion thereof. The port 129 of FIG. 1 includes an opening, for example, having a shape that is any of circular, rectangular, square, etc.

In the example of FIG. 1, the propellant 112 of thruster 102 can be implemented, for example, using Teflon and/or any other suitable propellant(s). The propellant 112 is sometimes referred to as fuel of the thruster 102. Additionally, in some examples, the thruster 102 of FIG. 1 also includes an example feed member (e.g., a spring) 130, which facilitates feeding the propellant 112 to the first conductor 118, the second conductor 120, and/or the ignition member 116. The feed member 130 can be operatively coupled to the propellant 112. In particular, in such examples, the feed member 130 is configured to urge the propellant 112 toward the ignition member 116, for example, by applying a biasing force to the propellant 112. In this manner, after part of the propellant changes into the plasma 110, the feed member 130 causes a remaining part of the propellant 112 to move across a relatively small distance toward the ignition member 116. As a result, the propellant 112 of FIG. 1 remains in proximity to the ignition member 116 as the propellant 112 is consumed during operation of the thruster 102.

The circuitry 108 of FIG. 1 can be implemented, for example, using one or more microcontrollers and/or any other suitable computing device(s). As previously described, in some examples, the circuitry 108 is configured to generate the plasma 110 via the ignition member 116. Further, in some examples, the circuitry 108 is configured to generate the magnetic field 114, via the first and second conductors 118, 120, that propels the plasma 110 away from the thruster 102 in the first direction 128. Additionally or alternatively, the circuitry 108 includes one or more circuit components, three of which are shown in this example. That is, the circuitry 108 of FIG. 1 includes a first circuit component (e.g., a capacitive component such as a capacitor) 132, a second circuit component (e.g., an inductive component such as an inductor) 134, and a third circuit component (e.g., a resistive component such as a resistor) 136. Additionally, in some examples, the circuitry 108 includes a power source electrically connected thereto, which facilitates providing electrical power to one or more (e.g., all) components of the circuitry 108 and/or the controller 106. The power source of the circuitry 108 can include, for example, one or more batteries, one or more solar cells, etc., any other suitable power source(s), or a combination thereof.

The first, second, and third circuit components 132, 134, 136 of FIG. 1 are connected together, for example, in series. As shown in FIG. 1, the first circuit component 132 can be electrically connected to the first conductor 118 to provide the electric current 124 to the first conductor 118. Further, the second circuit component 134 of FIG. 1 can be electrically connected between first and third circuit components 132, 136. Further still, the third circuit component 136 can be electrically connected to the second conductor 120 to receive the electric current 124 from the second conductor 120. In particular, the first circuit component 132 of FIG. 1 is configured to store (e.g., temporarily) electrical energy for a pulse of the thruster 102. Further, the first circuit component 132 of FIG. 1 is also configured to discharge the electrical energy during the pulse of the thruster 102, for example, via the first and second conductors 118, 120. In some examples, the first circuit component 132 can repeatedly store and discharge electrical energy in such a manner. In the example of FIG. 1, the first circuit component 132 can be implemented using a capacitor such as, for example, a fixed capacitor or a variable capacitor. As such, in some examples, the first circuit component 132 has a capacitance that can be substantially fixed or changed (e.g., increased or decreased) by the controller 106 and/or the circuitry 108.

In the example of FIG. 1, the first circuit component 132 can be charged via the power source of the circuitry 108. In some examples, to charge the first circuit component 132, the controller 106 is configured to control the circuitry 108 to apply a voltage (i.e., an input voltage) to the first circuit component 132 for a relatively short time interval, thereby changing the first circuit component 132 from a first state (e.g., an uncharged state) to a second state (e.g., a charged state). In such examples, when the first circuit component 132 is in the second state, the controller 106 is also configured to control the circuitry 108 to transmit the electric current 124 from the first circuit component 132 to the first conductor 118, the plasma 110, and the second conductor 120, thereby changing the first circuit component 132 from the second state to the first state. Such discharging of the first circuit component 132 can occur over a relatively short time interval.

Although FIG. 1 shows the first, second, and third circuit components 132, 134, 136, in some examples, the circuitry 108 of the thruster 102 is implemented differently while still sufficiently maintaining such functionality. For example, the circuitry 108 can include a plurality of first circuit components 132, a plurality of second circuit components 134, and/or a plurality of third circuit components 136, which can be connected together in series, parallel, or a combination thereof. Further, the circuitry 108 of FIG. 1 may alternatively be implemented using at least one of the circuit components 132, 134, 136 of FIG. 1 such as, for example, the first circuit component 132.

The sensor(s) 104 of FIG. 1 aid the controller 106 in detecting (e.g., continuously or repeatedly) the observed parameter(s) of the plasma 110 and/or one or more other parameters associated with the thruster 102. The other parameter(s) associated with the thruster 102 can include, for example, one or more electrical parameters of the circuitry 108, as discussed further below. The sensor(s) 104 FIG. 1 can be implemented, for example, using one or more laser sensors, one or more voltage sensors, etc., any other suitable sensor(s), or a combination thereof. The sensor(s) 104 of FIG. 1 are operatively coupled to the thruster 102 and/or the controller 106. In particular, the sensor(s) 104 are configured to generate sensor data (e.g., raw sensor data and/or processed sensor data) during operation of the thruster 102. In some examples, the sensor(s) 104 generate raw sensor data indicative of one or more (e.g., all) of the observed parameter(s) of the plasma 110. Additionally or alternatively, in some examples, the sensor(s) 104 generate raw sensor data indicative of one or more (e.g., all) of the other parameter(s) associated with the thruster 102. The sensor(s) 104 of FIG. 2 can obtain such raw sensor data continuously and/or repeatedly (e.g., periodically or a-periodically) during operation of the thruster 102. Further, in some examples, the sensor(s) 104 can be configured to detect any such parameter and provide related processed sensor data corresponding to the detection(s) to the controller 106.

In some examples, the sensor(s) 104 of FIG. 1 includes a receiver (e.g., a laser receiver) 138 and a transmitter (e.g., a laser transmitter) 140, which are represented by the dotted/dashed lines of FIG. 1. The receiver 138 and the transmitter 140 can form and/or define a single one of the sensor(s) 104. Alternatively, the receiver 138 and the transmitter 140 can be separate sensors configured to function cooperatively. In any case, the receiver and the transmitter 138, 140 of FIG. 1 are positioned on the thruster 102. For example, the receiver 138 is positioned at or adjacent an end of the second conductor 120, and the transmitter 140 is positioned at or adjacent and end of the first conductor 118 and proximate to the receiver 138. In particular, the receiver 138 of FIG. 1 is configured to receive a signal 142 (as represented by the dotted/dashed line of FIG. 1) from the transmitter 140. That is, the transmitter 140 of FIG. 1 is configured to generate the signal 142 and/or emit the signal 142. The signal 142 of FIG. 1, when generated, travels from the transmitter 140 to the receiver 138. In some examples, the receiver 138 and the transmitter 140 are positioned proximate to the port 129 such that the signal 142 intersects a trajectory of the plasma 110. As such, the plasma 110 generated by the thruster 102 can interrupt the signal 142 as the plasma 110 travels across a distance 144, which enables the receiver 138 to generate advantageous data related to the plasma 110. That is, the plasma 110 of FIG. 1 travels across the distance 144 while interrupting the signal 142. Such an interruption of the signal 142 can also serve as a trigger for the controller 106 to begin modulating the magnetic field 114. In such examples, the controller 106 is configured to control the circuitry 108 to modulate the magnetic field 114 in response to the plasma 110 interrupting the signal 142.

Additionally, in some examples (e.g., where the first and second conductors 118, 120 form a tubular body), the sensor(s) 104 of FIG. 1 are radially distributed relative to an axis 145 of the port 129. In such examples, the receiver 138 and the transmitter 140 are spaced apart from each other by an angle (e.g., about 180 degrees) relative to the axis 145.

During the thrust process, the transmitter 140 can operate using a certain wavelength, for example, that can be substantially between 100 kilohertz (KHz) and 200 KHz. That is, when the transmitter 140 generates the signal 142, the signal 142 has the particular wavelength. Further, in some examples, the receiver 138 and the transmitter 140 both operate using a certain voltage, for example, that is substantially between 12 V and 24 V. Further still, in some examples, the receiver 138 and the transmitter 140 both have a certain current consumption, for example, that is substantially between 10 milliamps (mA) and 20 mA.

Although FIG. 1 depicts the sensor(s) 104 that are implemented by the receiver 138 and the transmitter 140, in some examples, the sensor(s) 104 of FIG. 1 is/are implemented differently. For example, the sensor(s) 104 of FIG. 1 can include a plurality of receivers 138 and/or a plurality of transmitters 140, each of which is positioned on the thruster 102 and electrically connected to the controller 106. Accordingly, although FIG. 1 depicts aspects in connection with a single receiver 138 and a single transmitter 140, in some examples, such aspects likewise apply to the plurality of receivers 138 and/or the plurality of transmitters 140. In such examples, at least some or all of the plurality of receivers 138 and at least some or all of the plurality of transmitters 140 operate using the same operating parameters (e.g., any one or more a wavelength, a frequency, an intensity, etc.). Additionally or alternatively, in such examples, at least some or all of the plurality of receivers 138 and/or at least some or all of the plurality of transmitters 140 operate using different or unique operating parameters.

The controller 106 of FIG. 1 of FIG. 1 can be implemented, for example, using one or more microcontrollers and/or any other suitable computing device(s). In the example of FIG. 1, the controller 106 is operatively coupled to the thruster 102 and/or the sensor(s) 104. For example, the controller 106 can be electrically connected to the circuitry 108 to provide one or more advantageous control signals or commands to the circuitry 108. Further, the controller 106 can be electrically connected to the sensor(s) 104 to receive the sensor data from the sensor(s) 104. In some examples, the controller 106 interacts with the sensor(s) 104 to detect when the plasma 110 interrupts the signal 142 as well as when the plasma 110 ceases to interrupt the signal 142. In such examples, in response to the plasma 110 interrupting the signal 142, the controller 106 is configured to calculate an observed flight time of the plasma 110 based on a portion of the sensor data (e.g., timestamps) generated by the receiver 138. Further, the controller 106 is also configured to calculate an observed velocity (e.g., an instantaneous velocity) 146 of the plasma 110 based on the observed flight time of the plasma 110 and the distance 144 travelled by the plasma 110. In particular, in such examples, the controller 106 is also configured to calculate the observed thrust efficiency of the thruster 102 based on the observed velocity 146 of the plasma 110, as discussed further below. In some examples, the controller 106 performs such operations (including providing modulation to the magnetic field 114) in response to the plasma 110 interrupting the signal 142.

In some examples, to provide the thrust via the thruster 102, the circuitry 108 and/or the controller 106 is/are configured to initiate a thrust process of the thruster 102. The thrust process begins by controlling the ignition member 116 to generate the arc 122 that interacts with the propellant 112, which changes a portion of the propellant 112 from a first state (e.g., a solid state) to a second state (e.g., a gaseous state) different from the first state. This portion of the propellant 112 further changes into the plasma 110, which is charged. In such examples, the thrust process also includes storing electrical energy in the first circuit component 132 and discharging the electrical energy from the first circuit component 132 via the first and second conductors 118, 120 to provide the magnetic field 114 that propels the plasma 110. This manner of discharging the electrical energy to propel the plasma 110 is sometimes referred to as a pulse of the thruster 102. In particular, the circuitry 108 and/or the controller 106 can continuously or repeatedly execute the thrust process of the thruster 102 to provide a plurality of such plasmas and a plurality of such pulses for propelling respective ones of the plurality of plasmas. Accordingly, the thruster 102 of FIG. 1 can be controlled to provide substantially continuous thrust to the mass or body for a desired duration of time.

Additionally, the controller 106 of FIG. 1 has a primary processor 148 to facilitate providing automatic functions and/or controls of the thruster 102. In the example of FIG. 1, the primary processor 148 includes a feedback application 150 (e.g., installed on the primary processor 148), which provides instantaneous or near instantaneous control of the circuitry 108 based on the above-described sensor data provided by the sensor(s) 104. In some examples, the processor 148 of FIG. 1 is configured to execute the feedback application 150 during the thrust process of the thruster 102 to transmit (e.g., repeatedly or continuously) feedback control commands to the circuitry 108. In such examples, the circuitry of the thruster 102 can generate the magnetic field 114 in response to receiving the feedback commands. In particular, during the thrust process, a magnitude or strength of the magnetic field 114 can be controlled by the controller 106 via the feedback commands.

In the example of FIG. 1, the strength of the magnetic field 114 is based on the electrical parameter(s) of the circuitry 108. The electrical parameter(s) of the circuitry 108 include, for example, (a) a voltage (e.g., the input voltage) that is used in connection with charging the first circuit component 132 for a pulse of the thruster 102 and/or (b) a magnitude or strength of the electric current 124 that is discharged from the first circuit component 132 during the pulse. In some examples, to facilitate modulating the magnetic field 114, the controller 106 is configured to adjust, based on the sensor data generated by the sensor(s) 104, at least one of the electrical parameter(s) of the circuitry 108 during the thrust process. In such examples, the controller 106 controls the circuitry 108 to change (e.g., increase or decrease) the input voltage applied to the first circuit component 132, thereby changing (e.g., increasing or decreasing) the strength of the resulting magnetic field 114 during the pulse. Additionally or alternatively, in such examples, the controller 106 controls the circuitry 108 to change (e.g., increase or decrease) the strength of the electric current 124 that is discharged from the first circuit component 132 during the pulse, thereby changing (e.g., increasing or decreasing) the strength of the resulting magnetic field 114. Accordingly, in some examples, modulating the magnetic field 114 includes (a) increasing the strength of the magnetic field 114 during the thrust process and/or (b) decreasing the strength of the magnetic field 114 during the thrust process.

As shown in FIG. 1, the first and second conductors 118, 120 include respective inner surfaces 152, 154 that face each other. That is, the first conductor 118 of FIG. 1 includes a first inner surface (e.g., one of a flat surface or curved surface) 152, and the second conductor 120 of FIG. 1 includes a second inner surface (e.g., one of a flat surface or a curved surface) 154, at least a portion of which faces the first inner surface 152. Further, as shown in FIG. 1, the first and second conductors 118, 120 include respective cross-sectional areas 156, 158. That is, the first conductor 118 includes a first cross-sectional area 156, and the second conductor 120 includes a second cross-sectional area 158.

In some examples, each of the first and second cross-sectional areas 156, 158 has a dimension that is substantially uniform along a length 159 of the thruster 102. For example, the first conductor 118 of FIG. 1 has a first end 160 proximate to the propellant 112 and a second end 162 opposite the first end 160, which correspond to the length 159 of the thruster 102. In such examples, the first cross-sectional area 156 has a first thickness 164 that is uniform across the first conductor 118 from the first end 160 of the first conductor 118 to the second end 162 of the first conductor 118. Similarly, the second conductor 120 of FIG. 1 has a first end 166 proximate to the propellant 112 and a second end 168 opposite the first end 166, which correspond to the length 159 of the thruster 102. In such examples, the second cross-sectional area 158 has a second thickness 170 that is uniform across the second conductor 120 from the first end 166 of the second conductor 120 to the second end 168 of the second conductor 120. In such examples, the first thickness 164 associated with the first conductor 118 is substantially equal or the same relative to the second thickness 170 associated with the second conductor 120.

Additionally or alternatively, in some examples, the first conductor 118 is tapered, and/or the second conductor 118 is tapered. That is, in such examples, each of the first and second cross-sectional areas 156, 158 has a dimension that varies or is substantially non-uniform along the length 159 of the thruster 102. In such examples, the first thickness of the 164 of the first cross-sectional area 156 increases or decreases across the first conductor 118 from the first end 160 of the first conductor 118 to the second end 162 of the first conductor 118. Similarly, in some such examples, the second thickness 170 of the second cross-sectional area 158 increases or decreases across the second conductor 120 from the first end 166 of the second conductor 120 to the second end 168 of the second conductor 120.

Although FIG. 1 depicts an example implementation of the first and second conductors 118, 120, in some examples, the first conductor 118 of FIG. 1 and/or the second conductor 120 of FIG. 1 is/are implemented differently while still sufficiently maintaining functionality of the thruster 102. For example, the first conductor 118 of FIG. 1 can include a point conductor, and/or the second conductor 118 of FIG. 1 can include a point conductor. Further, the thruster 102 of FIG. 1 can be implemented using a plurality of first conductors 118 and/or a plurality of second conductors 120.

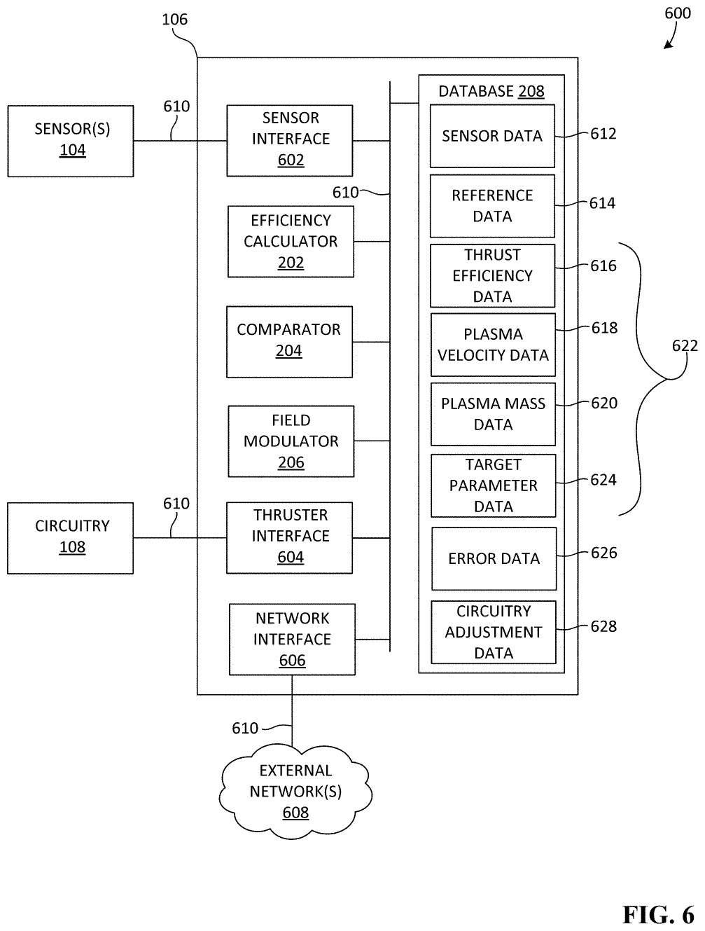

FIG. 2 illustrates a schematic diagram of an example control loop (e.g., a feedback control loop) 200 of the example propulsion system 100 of FIG. 1 in accordance with the teachings of this disclosure. According to the illustrated example of FIG. 2, the control loop 200 includes a feedback control loop, and the controller 106 includes a feedback controller (e.g., a PID controller) forming the control loop 200 with the thruster 102 and the sensor(s) 104. For example, when controlling the circuitry 108, the controller 106 of FIG. 2 employs one or more control strategies corresponding to any of (a) proportional feedback control, (b) integral feedback control, (c) derivative feedback control, (d) or a combination thereof (e.g., PID feedback control). In some examples, the controller 106 of FIG. 2 includes an example efficiency calculator 202, an example comparator 204, and an example field modulator 206 to perform one or more operations of the feedback application 150 of FIG. 1, each of which can be implemented by the primary processor 148. As will be discussed in greater detail below in connection with FIG. 6, the efficiency calculator 202, the comparator 204, and the field modulator 206, together, enable the controller 106 to determine when and/or how to control the circuitry 108 of the thruster 102 to improve (e.g., optimize) thruster performance.

The efficiency calculator 202 of FIG. 2 is operatively interposed between the sensor(s) 104 and the comparator 204. The efficiency calculator 202 of FIG. 2 is configured to receive the sensor data from the sensor(s) 104. In some examples, in response to receiving such data, the efficiency calculator 202 is configured calculate the observed thrust efficiency of the thruster 102 based on the sensor data, for example, using one or more related models and/or equations stored in the controller 106. As such, the observed thrust efficiency of the thruster 102 is sometimes referred to as a calculated efficiency. Further, in such examples, the efficiency calculator 202 is configured to transmit the observed or calculated thrust efficiency to the comparator 204 for comparison with the target thrust efficiency of the thruster 102. As previously described, the target thrust efficiency of the thruster 102 includes, for example, an optimal thrust efficiency of the thruster 102 that can be predefined and/or preprogrammed into the controller 106.

Additionally or alternatively, in some examples, the efficiency calculator 202 is similarly configured to calculate the observed velocity 146 of the plasma 110, for example, using one or more related models and/or equations stored in the controller 106. As such, the observed velocity 146 of the plasma 110 is sometimes referred to as a calculated plasma velocity. Further, in such examples, the efficiency calculator 202 is configured to transmit the observed or calculated velocity 146 of the plasma 110 to the comparator 204 for comparison with a predefined or target velocity (e.g., an optimal velocity) of the plasma 110. The observed thrust efficiency of the thruster 102 and the observed velocity 146 of the plasma 110 calculated by the efficiency calculator 202 may be instantaneous parameters. Accordingly, in some examples, the efficiency calculator 202 is configured to repeatedly calculate such instantaneous parameter(s) in response to the sensor(s) 104 generating updated or new sensor data during the thrust process.

The comparator 204 of FIG. 2 is operatively interposed between the efficiency calculator 202, the field modulator 206, and an example database 208 of the controller 106. The comparator 204 is configured to process (a) data provided by the efficiency calculator 202 and (b) data provided by the database 208. For example, the comparator 204 is configured to perform one or more comparisons of data generated by the efficiency calculator 202 with predefined or target data stored in the database 208. Further, the comparator 204 is configured to transmit results of the comparison(s) to the field modulator 206. The results of the comparison(s) enable the field modulator 206 to calculate and/or determine one or more adjustments for the circuitry 108 associated with modulating the magnetic field 114. In some examples, the comparator 204 calculates one or more error values based on the comparison and transmits the error value(s) to the field modulator 206. For example, the comparator 204 can calculate a first error value corresponding to a difference between the observed thrust efficiency and the target thrust efficiency. In another example, the comparator 204 can calculate a second error value corresponding to a difference between the observed velocity 146 of the plasma 110 and the target velocity of the plasma 110.

The field modulator 206 of FIG. 2 is operatively interposed between the comparator 204 and the circuitry 108 of the thruster 102. In particular, the field modulator 206 is configured to receive data (e.g., any of the comparison result(s), the error value(s), etc.) provided by the comparator 204 and, based on such data, calculate and/or determine the adjustment(s) for the circuitry 108 associated with modulating the magnetic field 114. Then, the field modulator 206 and/or, more generally, the controller 106 is configured to carry out or execute the adjustment(s), thereby controlling the strength of the magnetic field 114. In some examples, the field modulator 206 and/or, more generally, the controller 106 is configured to adjust the electrical parameter(s) of the circuitry 108 based on the adjustment(s). The adjustment(s), when executed by the controller 106, cause the strength of the magnetic field 114 to change (e.g., increase or decrease).

In some examples (e.g., where the controller 106 includes a feedback controller), the field modulator 206 is configured to generate, based on the data received from the comparator 204, the feedback control commands for controlling the circuitry 108 or the first circuit component 132. In such examples, the circuitry 108 of the thruster 102 can generate the magnetic field 114 based on the feedback control commands to provide rapid control, compensation, and/or correction with respect to reducing the error value(s) calculated by the comparator 204. Further, in such examples, the field modulator 206 can update (e.g., continuously or repeatedly) the feedback control commands to enable the circuitry 108 to adjust the strength of the magnetic field based on changes of, for example, the observed thrust efficiency of the thruster 102, the observed velocity 146 of the plasma 110, and/or any other characteristic(s) or parameter(s) associated with the thruster 102. Accordingly, the efficiency calculator 202, the comparator 204, and the field modulator 206, together, may process subsequent sensor data received from the sensor(s) to determine whether and/or how to update the feedback control commands. In this manner, a time varying strength of the magnetic field 114 is facilitated by the controller 106 and based on the subsequent sensor data.

Although FIG. 2 depicts the control loop 200 and the controller 106 that are associated with feedback control, in some examples, the control loop 200 and/or the controller 106 can be implemented differently. In such examples, the control loop 200 of FIG. 2 can include a feedforward control loop, and the controller 106 of FIG. 2 can include a feedforward control component that forms the feedforward control loop.

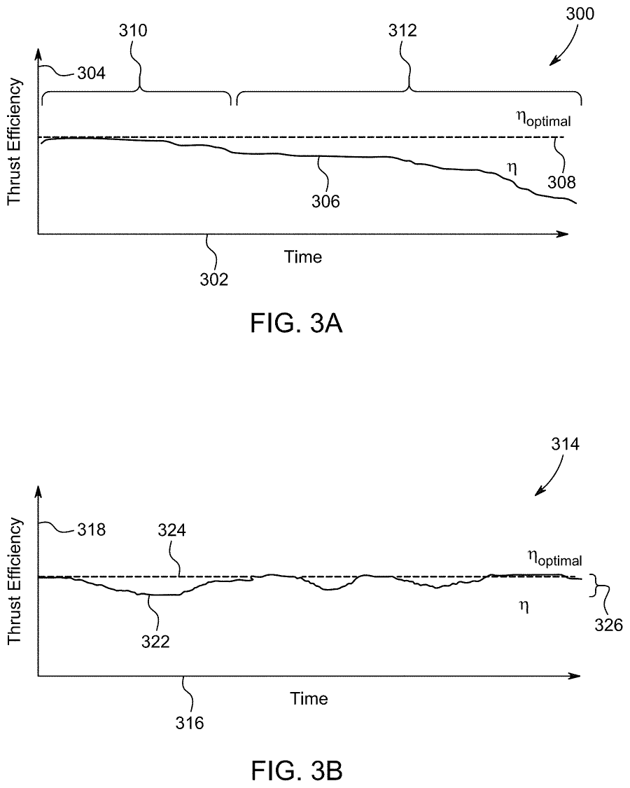

FIG. 3A is a first graph 300 illustrating an example operating characteristic of the thruster 102. The first graph 300 includes a first axis (e.g., an x-axis) 302 representing time (e.g., in seconds) and a second axis 304 (e.g., a y-axis) representing thrust efficiency of the thruster 102. The first graph 300 of FIG. 3A also includes a first plot 306 representing the observed thrust efficiency of the thruster 102 over time and a second plot 308 representing the target thrust efficiency of the thruster 102 over time. Movement of the first and second plots 306, 308 is from left to right in the orientation of FIG. 3A. As shown in FIG. 3A, the target thrust efficiency of the thruster 102 can be constant over time. In particular, according to the illustrated example of FIG. 3A, the controller 106 is not providing modulation to the magnetic field 114 during the thrust process of the thruster 102. For example, the primary processor 148 is not executing the feedback application 150. As a result, the observed thrust efficiency of the thruster 102 is substantially equal to the target thrust efficiency of the thruster 102 only during an initial or first time interval 310 of the thrust process. However, as shown in FIG. 3A, the observed thrust efficiency of the thruster 102 substantially decreases relative to the target thrust efficiency during a second time interval 312 of the thrust process occurring after the first time interval 310. For example, the first plot 306 of FIG. 3A substantially diverges from the second plot 308 during the second time interval 312.

FIG. 3B is a second graph 314 illustrating a different operating characteristic of the thruster 102. The second graph 314 includes a third axis (e.g., an x-axis) 316 representing time and a fourth axis (e.g., a y-axis) 318 representing the thrust efficiency of the thruster 102. The second graph 314 of FIG. 3B also includes a third plot 322 representing the observed thrust efficiency of the thruster 102 over time and a fourth plot 324 representing the target thrust efficiency of the thruster 102 over time. Movement of the third and fourth plots 322, 324 is from left to right in the orientation of FIG. 3B. In particular, according to the illustrated example of FIG. 3B, the controller 106 is controlling the circuitry 108 during the thrust process to modulate the magnetic field 114 in accordance with the teachings of this disclosure. For example, the primary processor 148 is executing the feedback application 150. As a result, the observed thrust efficiency of the thruster 102 is substantially equal to the target thrust efficiency, for example, during the entire thrust process of the thruster 102. For example, unlike the illustrated example of FIG. 3A, the third plot 322 of FIG. 3B does not substantially diverge from the fourth plot 324.

Additionally, in some examples, when the controller 106 is providing modulation to the magnetic field 114 (e.g., during execution of the feedback application 150), the observed thrust efficiency of the thruster 102 remains within a first range (e.g., +/−5% of the target thrust efficiency) 326 relative to the target thrust efficiency. For example, the first range 326 of FIG. 3B can be defined between a first value (e.g., 95% of the target thrust efficiency) less than the target thrust efficiency and a second value (e.g., 105% of the target thrust efficiency) greater than the target thrust efficiency. In such examples, the controller 106 may allow the observed thrust efficiency of the thruster 102 to fluctuate between the first value and the second value.

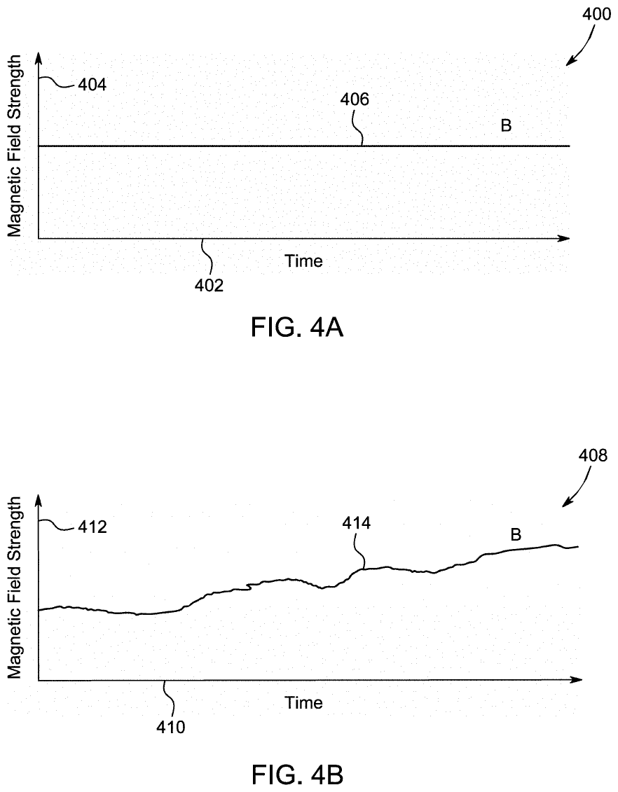

FIG. 4A is a third graph 400 illustrating a different operating characteristic of the thruster 102. The third graph 400 includes a fifth axis (e.g., an x-axis) 402 representing time (e.g., in seconds) and a sixth axis 404 (e.g., a y-axis) representing magnetic field strength. The third graph 400 of FIG. 4A also includes a fifth plot 406 representing the strength of the magnetic field 114 of FIG. 1 over time. Movement of the fifth plot 406 is from left to right in the orientation of FIG. 4A. In particular, according to the illustrated example of FIG. 4A, the controller 106 is not providing modulation to the magnetic field 114 during the thrust process of the thruster 102. For example, the primary processor 148 is not executing the feedback application 150. As a result, the strength of the magnetic field 114 is substantially constant, for example, during the entire thrust process of the thruster 102.

FIG. 4B is a fourth graph 408 illustrating a different operating characteristic of the thruster 102. The fourth graph 408 includes a seventh axis (e.g., an x-axis) 410 representing time and an eighth axis (e.g., a y-axis) 412 representing magnetic field strength. The fourth graph 408 of FIG. 4B also includes a sixth plot 414 representing the strength of the magnetic field 114 over time. Movement of the sixth plot 414 is from left to right in the orientation of FIG. 4B. In particular, according to the illustrated example of FIG. 4B, the controller 106 is controlling the circuitry 108 during the thrust process to modulate the magnetic field 114 in accordance with the teachings of this disclosure. For example, the primary processor 148 is executing the feedback application 150. As a result, the strength of the magnetic field 114 of FIG. 1 varies over time, for example, during the entire thrust process of the thruster 102. For example, in contrast to the illustrated example of FIG. 4A, the sixth plot 414 of FIG. 4B shows a positive trend of the strength of the magnetic field 114 over time. That is, such control of the circuitry 108 causes the strength of the magnetic field 114 to generally increase over time.

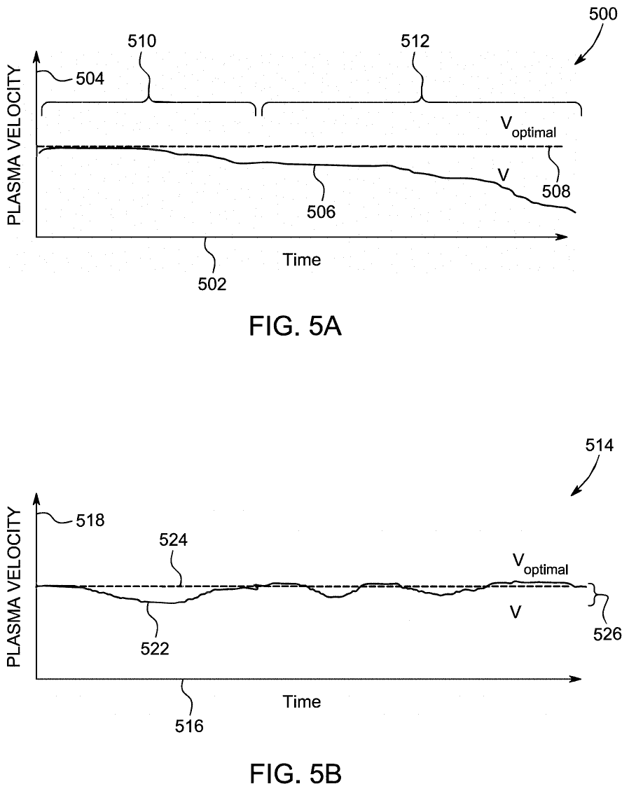

FIG. 5A is a fifth graph 500 illustrating a different operating characteristic of the thruster 102. The fifth graph 500 includes a ninth axis (e.g., an x-axis) 502 representing time (e.g., in seconds) and a tenth axis 504 (e.g., a y-axis) representing plasma velocity associated with the thruster 102. The fifth graph 500 of FIG. 5A also includes a seventh plot 506 representing the observed velocity 146 of the plasma 110 over time and an eighth plot 508 representing the target velocity of the plasma 110 over time. Movement of the seventh and eighth plots 506, 508 is from left to right in the orientation of FIG. 5A. As shown in FIG. 5A, the target velocity of the plasma 110 can be constant over time. In particular, according to the illustrated example of FIG. 5A, the controller 106 is not providing modulation to the magnetic field 114 during the thrust process of the thruster 102. For example, the primary processor 148 is not executing the feedback application 150. As a result, the observed velocity 146 of the plasma 110 is substantially equal to the target velocity of the plasma 110 only during a third time interval 510 of the thrust process. However, as shown in FIG. 5B, the observed velocity 146 of the plasma 110 substantially decreases relative to the target velocity of the plasma 110 during a fourth time interval 512 of the thrust process occurring after the third time interval 510. For example, the seventh plot 506 of FIG. 5A substantially diverges from the eighth plot 508 during the fourth time interval 512. In some examples, the third time interval 510 corresponds to the first time interval 310, and the fourth time interval 512 corresponds to the second time interval 312.

FIG. 5B is a sixth graph 514 illustrating a different operating characteristic of the thruster 102. The sixth graph 514 includes an eleventh axis (e.g., an x-axis) 516 representing time and a twelfth axis (e.g., a y-axis) 518 representing the plasma velocity associated with the thruster 102. The sixth graph 514 of FIG. 5B also includes a ninth plot 522 representing the observed velocity 146 of the plasma 110 over time and a tenth plot 524 representing the target velocity of the plasma 110 over time. Movement of the ninth and tenth plots 522, 524 is from left to right in the orientation of FIG. 5B. In particular, according to the illustrated example of FIG. 5B, the controller 106 is controlling the circuitry 108 during the thrust process to modulate the magnetic field 114 in accordance with the teachings of this disclosure. For example, the primary processor 148 is executing the feedback application 150. As a result, the observed velocity 146 of the plasma 110 is substantially equal to the target velocity of the plasma 110, for example, during the entire thrust process of the thruster 102. For example, unlike the illustrated example of FIG. 5A, the ninth plot 522 of FIG. 5B does not substantially diverge from the tenth plot 524. In some such examples, the controller 106 generates and/or updates (e.g., via the field modulator 206) the aforementioned feedback commands such that the resulting strength of the magnetic field 114 is proportional to the second error value calculated by the comparator 204. As previously described, the second error value can include a difference between the observed velocity 146 of the plasma 110 and the target velocity of the plasma 110.

According to the illustrated example of FIG. 5B, the controller 106 is configured to control the circuitry 108 to increase the strength of the magnetic field 114 when the observed velocity 146 of the plasma 110 is less than the target velocity of the plasma 110. Additionally or alternatively, according to the illustrated example of FIG. 5B, the controller 106 is configured to control the circuitry 108 to decrease the strength of the magnetic field 114 when the observed velocity 146 of the plasma 110 is greater than the target velocity of the plasma 110. In particular, when the controller 106 is providing modulation to the magnetic field 114 (e.g., during execution of the feedback application 150), the observed velocity 146 of the plasma 110 remains within a second range (e.g., +/−5% of the target velocity) 526 relative to the target velocity of the plasma 110. For example, the second range 526 of FIG. 5B can be defined between a third value (e.g., 95% of the target velocity) less than the target velocity of the plasma 110 and a fourth value (e.g., 105% of the target velocity) greater than the target velocity of the plasma 110. In such examples, the controller 106 may allow the observed velocity of the plasma 110 to fluctuate between the third value and the fourth value.

FIG. 6 is a block diagram of an example control system 600 in accordance with the teachings of this disclosure. The control system 600 can be implemented, for example, by the controller 106 of FIGS. 1 and 2. According to the illustrated example of FIG. 6, the control system 600 includes the example efficiency calculator 202, the example comparator 204, the example field modulator 206, the example database 208, an example sensor interface 602, an example thruster interface 604, and an example network interface 606. The control system 600 of FIG. 6 is communicatively coupled to the sensor(s) 104, the circuitry 108 of the thruster 102, and one or more external networks 608 via one or more example communication links 610 such as, for example, one or more signal or transmission wires, a bus, radio frequency, etc. In particular, the thruster interface 604 of FIG. 6 is configured to provide one or more control signals or commands and/or electrical power (e.g., the feedback commands) to the circuitry 108 of the thruster 102 to modulate the magnetic field 114 during the thrust process of the thruster 102, thereby maintaining the observed thrust efficiency of the thruster 102 at the target thrust efficiency.

In the example of FIG. 6, the efficiency calculator 202 processes example sensor data (e.g., raw sensor data and/or pre-processed sensor data) 612 generated by the sensor(s) 104. The efficiency calculator 202 of FIG. 6 is configured to receive the sensor data 612 via the link(s) 610, for example, from the database 208 and/or the sensor interface 602. In particular, the efficiency calculator 202 of FIG. 6 performs one or more calculations associated with determining the observed thrust efficiency of the thruster 102, for example, via example reference data 614 (e.g., stored in the database 208). To facilitate calculations, the reference data 614 of FIG. 6 can include one or more equations, one or more models, one or more look-up tables, one or more algorithms, and/or one or more methods or techniques related to calculating or determining thrust efficiency based on the sensor data 612. The reference data 614 can be preprogrammed into the control system 600 and/or otherwise stored in the database 208 prior to thruster operation.

Efficiency of thrust can be defined as a ratio of directed exhaust kinetic energy to energy initially stored by the first circuit component 132. In some examples, the efficiency calculator 202 of FIG. 6 uses Eq. (1) below to calculate (e.g., repeatedly) the observed thrust efficiency of the thruster 102:

$$η = \frac{\frac{1}{2} m {v}^{2}}{C {V}^{2}} \qquad ( 1 )$$

In Eq. (1) above, η represents a value (e.g., a numerical value) corresponding to the observed thrust efficiency of the thruster 102, m represents a value corresponding to a mass of the plasma 110, v represents a value corresponding to the observed velocity 146 of the plasma 110, C represents a value corresponding to the capacitance of the first circuit component 132, and V represents a value corresponding to the input voltage applied to the first circuit component 132. As such, the reference data 614 of FIG. 6 can include Eq. (1) such that Eq. (1) is accessible to the efficiency calculator 202 during the thrust process of the thruster 102. In some examples, after calculating the observed thrust efficiency of the thruster 102 at least once, the efficiency calculator 202 stores the observed thrust efficiency in the database 208 as example thrust efficiency data 616. Further, the efficiency calculator 202 can update the thrust efficiency data 616 with subsequent calculation(s) of observed thrust efficiencies. Additionally or alternatively, the efficiency calculator 202 can transmit, via the link(s) 610, the observed thrust efficiency and/or the related thrust efficiency data 616 directly to comparator 204 for further processing.

Additionally, in some examples, the efficiency calculator 202 of FIG. 6 performs one or more calculations associated with determining the observed velocity 146 of the plasma 110, for example, via the reference data 614. In such examples, the reference data 614 of FIG. 6 can include one or more equations, one or more models, one or more look-up tables, one or more algorithms, and/or one or more methods or techniques related to calculating or determining plasma velocity based on the sensor data 612. In particular, in such examples, the efficiency calculator 202 of FIG. 6 uses Eq. (2) below to calculate (e.g., repeatedly) the observed velocity 146 of the plasma 110:

$$v = \frac{Δ d}{Δ t} \qquad ( 2 )$$

In Eq. (2) above, v represents the observed velocity 146 of the plasma 110, Δd represents the distance 144 traveled by the plasma 110, and Δt represents the observed flight time of the plasma 110. That is, Δt represents a time interval during which the plasma 110 travels across the distance 144. As such, the reference data 614 of FIG. 6 can include Eq. (2) such that Eq. (2) is accessible to the efficiency calculator 202 during the thrust process of the thruster 102. In some examples, after calculating the observed velocity 146 of the plasma 110 at least once, the efficiency calculator 202 stores the observed velocity 146 of the plasma 110 in the database 208 as example plasma velocity data 618. Further, the efficiency calculator 202 can update the plasma velocity data 618 with subsequent calculation(s) of observed plasma velocities. Additionally or alternatively, the efficiency calculator 202 can transmit, via the link(s) 610, the observed velocity 146 of the plasma 110 and/or the related plasma velocity data 618 directly to comparator 204 for further processing.

Additionally, in some examples, the efficiency calculator 202 of FIG. 6 performs one or more calculations associated with determining a mass of the plasma 110. In such examples, the reference data 614 of FIG. 6 includes one or more equations, one or more models, one or more look-up tables, one or more algorithms, and/or one or more methods or techniques related to calculating or determining plasma mass based on the sensor data 612. In particular, in such examples, the efficiency calculator 202 uses Eq. (3) below to calculate (e.g., repeatedly) an observed mass of the plasma 110, which represents the Michels et al. [1966] model:

$$m ( t ) = {m}_{o} + {m}_{t} \{ 1 - {( 1 - \frac{{x}_{s} ( t )}{l} )}^{\frac{1}{1 - α}} \} \qquad ( 3 )$$

See Michels, C. J., Heighway, J. E., Johansen, A. E., “Analytical and Experimental Performance of Capacitor Powered Coaxial Plasma Guns,” AIAA Journal, Vol. 4, No. 5, May 1966, which is incorporated herein by reference in its entirety. In Eq. (3) above, m(t) represents a value corresponding to the observed mass of the plasma 110 as a function of time, mₒ represents a value corresponding to an initial current sheet mass, mₜ represents a value corresponding to an additional mass entrained or taken up into the current sheet, xₛ(t) represents a value corresponding to the position of the current sheet measured at the trailing edge of the current sheet, l represents a value corresponding to channel length, and α represents a value corresponding to a distribution loading parameter. As such, the reference data 614 of FIG. 6 can include Eq. (3) such that the Eq. (3) is accessible to the efficiency calculator 202 during operation of the thruster 102. In some examples, to facilitate the calculation(s) performed by the efficiency calculator 202 and/or reduce time taken to perform the calculation(s), m(t) is assumed to be constant and substantially equal to mₒ, for example, by setting the value of α to 1 (i.e., α=1). In some examples, after calculating the observed mass of the plasma 110 at least once, the efficiency calculator 202 stores the observed mass of the plasma 110 in the database 208 as example plasma mass data 620. Thus, in some examples, the efficiency calculator 202 advantageously uses the plasma velocity data 618 and/or the plasma mass data 620 as input data with which to generate the thrust efficiency data 616.

In the example of FIG. 6, the comparator 204 processes example data of interest 622. The comparator 204 of FIG. 6 is configured to receive the data of interest 622 via the link(s) 610, for example, from the database 208 and/or the efficiency calculator 202. The data of interest 622 can include at least some data generated by the efficiency calculator 202. For example, the data of interest 622 of FIG. 6 includes the thrust efficiency data 616, the plasma velocity data 618, the plasma mass data 620, and example target parameter data 624. In particular, the comparator 204 of FIG. 6 performs one or more comparisons of the thrust efficiency data 616 with the target parameter data 624, thereby generating example error data 626. Additionally or alternatively, in some examples, the efficiency calculator 202 performs one or more comparisons of the plasma velocity data 618 with the target parameter data 624, thereby generating the error data 626 or at least a portion thereof.

The target parameter data 624 of FIG. 6 can be preprogrammed into the control system 600 and/or otherwise stored in the database 208 prior to thruster operation. In some examples, the target parameter data 624 is provided to the control system 600 and/or updated therein via the network interface 606. In particular, the target parameter data 624 includes the target thrust efficiency of the thruster 102 (e.g., see the fourth plot 324 of FIG. 3B). The target parameter data 624 can also include a criterion or criteria, which aids the comparator 204 in analyzing compared data. In some examples, the comparator 204 performs a first comparison of the observed thrust efficiency of the thruster 102 with the target thrust efficiency of the thruster 102. Based on the first comparison, the comparator 204 calculates and/or determines, for example, a difference between the observed thrust efficiency of the thruster 102 and the target thrust efficiency of the thruster 102 (i.e., the first error value). Further, the comparator 204 is also configured to determine whether the first comparison satisfies a first criterion of the target parameter data 624. In such examples, the first criterion can include a first threshold value (e.g., an absolute value) corresponding to a maximum allowable difference between of the observed thrust efficiency of the thruster 102 and the target thrust efficiency of the thruster 102.

Additionally or alternatively, in some examples, the target parameter data 624 of FIG. 6 includes the target velocity of the plasma 110 (e.g., see the tenth plot 524 of FIG. 5B). In such examples, the comparator 204 performs a second comparison of the observed velocity 146 of the plasma 110 with the target velocity of the plasma 110. Based on the second comparison, the comparator 204 calculates and/or determines, for example, a difference between the observed velocity 146 of the plasma 110 and the target velocity of the plasma 110 (i.e., the second error value). Further, the comparator 204 is also configured to determine whether the second comparison satisfies a second criterion and/or a third criterion of the target parameter data 624. The second criterion can include a lower threshold value corresponding to a minimum allowable velocity of the plasma 110, and the third criterion can include an upper threshold value corresponding to a maximum allowable velocity of the plasma 110. For example, the lower threshold is 95% of the target velocity of the plasma 110, and the upper threshold is 105% of the target velocity of the plasma 110. However, in some examples, the lower threshold and/or the upper threshold can be set differently while still sufficiently maintaining the thrust efficiency of the thruster 102 during the thrust process.

In the example of FIG. 6, the field modulator 206 processes the error data 626. The field modulator 206 of FIG. 6 is configured to receive the error data 626 via the link(s) 610, for example, from the comparator 204 and/or the database 208. In particular, the field modulator 206 is configured to use the reference data 614 to calculate and/or determine, based on the error data 626, the adjustment(s) for the circuitry 108 associated with the modulating the magnetic field 114. In such examples, the reference data 614 of FIG. 6 includes one or more equations, one or more models, one or more look-up tables, one or more algorithms, and/or one or more methods or techniques related to calculating or determining one or more circuitry adjustments based on the error data 626. For example, the reference data 614 of FIG. 6 correlates the error value(s) calculated by the comparator 204 with certain changes of the electrical parameter(s) of the circuitry 108 that result in maintaining the observed thrust efficiency of the thruster 102 at the target thrust efficiency. Further, the field modulator 206 of FIG. 6 can store the determined adjustment(s) in the database 208 as example circuitry adjustment data 628. Additionally or alternatively, the field modulator 206 can transmit, via the link(s) 610, the adjustment(s) and/or the related circuitry adjustment data 628 directly to the thruster interface 604 for execution or communication with the circuitry 108.

In the example of FIG. 6, the thruster interface 604 facilitates interactions and/or communications between the control system 600 and the circuitry 108 of the thruster 102. The thruster interface 604 of FIG. 6 is communicatively coupled to the circuitry 108 via the link(s) 610, for example, to provide (e.g., continuously or repeatedly) data to the circuitry 108 and/or receive (e.g., continuously or repeatedly) data from the circuitry 108. Further, the thruster interface 604 processes the adjustment(s) and/or, more generally, processes the circuitry adjustment data 628 generated by the field modulator 206. In particular, the thruster interface 604 of FIG. 6 is configured to convert the circuitry adjustment data 628 into the control signal(s) or command(s) and/or electrical power provided to the circuitry 108. That is, the thruster interface 604 is configured to direct the circuitry 108 based on the circuitry adjustment data 628 to modulate the magnetic field 114 in accordance with the teachings of this disclosure.

In some examples, the thruster interface 604 is configured to adjust one or more (e.g., all) of the electrical parameter(s) of the circuitry 108 based on the adjustment(s) determined by the field modulator 206. For example, based on a first one of the adjustment(s), the thruster interface 604 controls the circuitry 108 to change (e.g., increase or decrease) the input voltage applied to the first circuit component 132 in connection with generating a pulse of the thruster 102. Further, in another example, based on a second one of the adjustment(s), the thruster interface 604 controls the circuitry 108 to change (e.g., increase or decrease) the strength of the current 124 discharged from the first circuit component 132 during the pulse of the thruster 102.

In the example of FIG. 6, the sensor interface 602 of FIG. 6 facilitates interactions and/or communications between the control system 600 and the sensor(s) 104. The sensor interface 602 of FIG. 6 is communicatively coupled to the sensor(s) 104 via the link(s) 610 to receive (e.g., continuously or repeatedly) the sensor data 612 from the sensor(s) 104. The sensor data 612 of FIG. 6 includes and/or indicates to the sensor interface 602, for example, one or more (e.g., all) of the observed parameter(s) of the plasma 110 and/or the other parameter(s) of the thruster 102. In some examples, the sensor data 612 includes and/or indicates to the sensor interface 602 any of (a) the distance 144 travelled by the plasma 110, (b) the flight time of the plasma 110, (c) the observed velocity 146 of the plasma 110, (d) the mass of the plasma 110, (e) the capacitance of the first circuit component 132, (0 the input voltage applied to the first circuit component 132, (g) the strength of the magnetic field 114, (h) the strength of the electric current 124, (i) etc., (j) any other suitable parameter(s), or (k) a combination thereof. The sensor interface 602 is configured to store the sensor data 612 in the database 208 and/or transmit the sensor data 612 directly to the efficiency calculator 202 for processing.

In some examples, the sensor interface 602 of FIG. 6 receives time data (e.g., timestamps) from the receiver 138. For example, during a pulse of the thruster 102 in which the plasma 110 interrupts the signal 142, the sensor interface 602 receives a first timestamp corresponding to when the plasma 110 begins to interrupt the signal 142. Further, the sensor interface 602 subsequently receives a second timestamp corresponding to when the plasma 110 ceases to interrupt the signal 142. In such examples, the first and second timestamps, together with the distance 144 travelled by the plasmas 110, enable the efficiency calculator 202 to calculate and/or determine the observed velocity 146 of the plasma 110.

In the example of FIG. 6, the network interface 606 facilitates interactions and/or communications between the control system 600 and the external network(s) 608. The network interface 606 of FIG. 6 is communicatively coupled to the external network(s) 608 via the link(s) 610 to receive data therefrom and/or provide data thereto. The external network(s) 608 are external to the control system 600. The external network(s) 608 include, for example, any of a controller area network (CAN), a local area network (LAN), a wide area network (WAN), a satellite network, the Internet, etc. In some examples, the network interface 606 communicates with the external network(s) 608 to update at least some of the data in the database 208 such as, for example, the reference data 614 and/or the target parameter data 624.

In the example of FIG. 6, the database 208 stores (e.g., temporarily and/or permanently) and/or provides access to at least some or all of the data 612, 614, 616, 618, 620, 622, 624, 626, 628 in the database 208. The database 208 of FIG. 6 is communicatively coupled, via the link(s) 610, to the efficiency calculator 202, the comparator 204, the field modulator 206, the sensor interface 602, the thruster interface 604, and the network interface 606. In some examples, any one or more (e.g., all) of the efficiency calculator 202, the comparator 204, the field modulator 206, the sensor interface 602, the thruster interface 604, and/or the network interface 606 transmit (e.g., repeatedly and/or continuously) data to the database 208. Conversely, in some examples, the database 208 transmits (e.g., repeatedly or continuously) data to any one or more (e.g., all) of the efficiency calculator 202, the comparator 204, the field modulator 206, the sensor interface 602, the thruster interface 604, and the network interface 606.

Although an example control system 600 is illustrated in FIG. 6, one or more of the elements, processes, and/or devices depicted in FIG. 6 may be combined, divided, re-arranged, omitted, eliminated, and/or implemented in any other way. Further, the example control system 600 of FIG. 6 may include one or more elements, processes, and/or devices in addition or alternatively to those illustrated in FIG. 6, and/or may include more than one of any of the illustrated elements, processes, and devices.

Additionally, one or more of the example controller 106, the example efficiency calculator 202, the example comparator 204, the example field modulator 206, the example database 208, the example sensor interface 602, the example thruster interface 604, the example network interface 606, and/or, more generally, the example control system 600 of FIG. 6 may be implemented by hardware, software, firmware and/or any combination thereof. For example, one or more (e.g., all) of the example controller 106, the example efficiency calculator 202, the example comparator 204, the example field modulator 206, the example database 208, the example sensor interface 602, the example thruster interface 604, the example network interface 606, and/or, more generally, the example control system 600 could be implemented by one or more circuits (e.g., an analog or digital circuit, a logic circuit, a programmable processor, etc.). Further, in some examples, at least one of the example controller 106, the example efficiency calculator 202, the example comparator 204, the example field modulator 206, the example database 208, the example sensor interface 602, the example thruster interface 604, the example network interface 606, and/or the example control system 600 include(s) a tangible machine-readable storage device or storage disk (e.g., a memory storing the software and/or firmware).

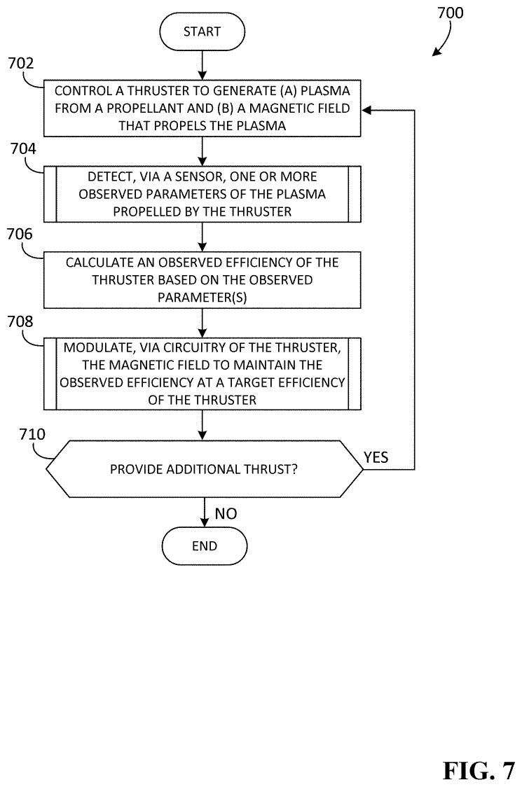

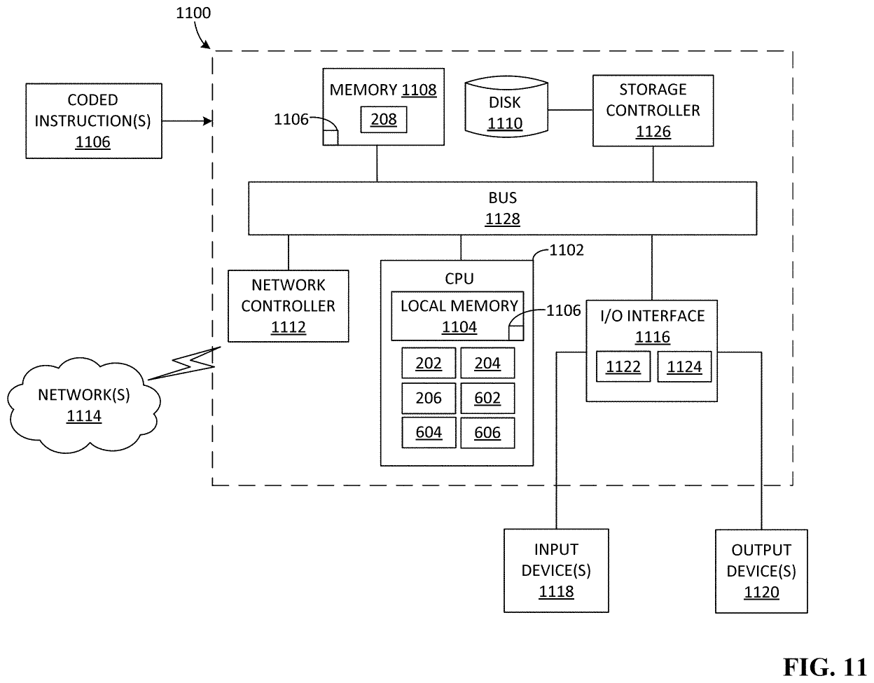

Flowcharts representative of example hardware logic or machine-readable instructions for implementing the example control system 600 of FIG. 6 are shown in FIGS. 7-10. The machine-readable instructions may be a program or portion of a program for execution by a processor such as the processor 1102 shown in the example processor platform 1100, which is discussed in greater detail below in connection with FIG. 11. The program may be embodied in software stored on a tangible machine-readable storage medium such as a CD-ROM, a floppy disk, a hard drive, or a memory associated with the processor 1102, but the entire program and/or parts thereof could be alternatively executed by a different device and/or embodied in firmware or dedicated hardware. Further, although the example program is described with reference to the flowcharts illustrated in FIGS. 7-10, many other methods of implementing the example control system 600 may alternatively be used. For example, the order of execution of the blocks may be changed, and/or some of the blocks described may be changed, eliminated, or combined. Additionally or alternatively, any of the blocks may be implemented by one or more hardware circuits (e.g., discrete and/or integrated analog and/or digital circuitry, logic circuit, a comparator, etc.).

As mentioned above, the example processes of FIGS. 7-10 may be implemented using executable or coded instructions (e.g. computer or machine readable instructions) stored on a tangible machine-readable storage medium such as a hard disk drive, a compact disk (CD), a flash memory, and/or other storage device or disk in which information is stored for any duration of time. As used herein, the term tangible machine-readable storage medium is expressly defined to include any type of computer or machine-readable storage device or disk and exclude propagating signals and all transmission media. Additionally or alternatively, the example methods of FIGS. 7-10 may be implemented using coded instructions stored on a non-transitory machine-readable medium in which information is stored for any duration, which includes any type of computer or machine readable storage device or disk and excludes propagating signals and transmission media.

FIG. 7 is a flowchart representative of an example method 700 that can be executed to implement the example control system of FIG. 6 to provide thrust to a body or mass. The example method 700 can be implemented in any of the propulsion system 100 of FIG. 1, the thruster 102 of FIGS. 1 and 2, and/or the controller 106 of FIGS. 1, 2, and 6.

The example method 700 of FIG. 7 begins by controlling a thruster to generate (a) plasma from a propellant and (b) a magnetic field that propels the plasma (block 702). In some examples, the control system 600 of FIG. 6 controls (e.g., via the thruster interface 604) the circuitry 108 of the thruster 102 to generate (a) the plasma 110 from the propellant 112 (e.g., via the ignition member 116) and (b) the magnetic field 114 (e.g., via the first and second conductors 118, 120) that propels the plasma 110 away from the thruster 102 in the first direction 128.

The example method 700 of FIG. 7 also includes detecting, via a sensor, one or more observed parameters of the plasma propelled by the thruster (block 704). In some examples, the control system 600 of FIG. 6 detects, via the sensor(s) 104, one or more (e.g., all) of the aforementioned observed parameter(s) of the plasma 110 of FIG. 1. For example, the sensor interface 602 detects the observed velocity 146 of the plasma 110 based on the sensor data 612 generated by the sensor(s) 104. Additionally, in some examples at block 704, the control system 600 also detects one or more (e.g., all) of the electrical parameter(s) of the circuitry 108 such as, for example, the input voltage applied to the first circuit component 132 and/or the capacitance of the first circuit component 132.

The example method 700 of FIG. 7 also includes calculating an observed efficiency of the thruster based on the observed parameter(s) (block 706). In some examples, the control system 600 of FIG. 6 calculates (e.g., via the efficiency calculator 202) the observed thrust efficiency of the thruster 102 based on the parameter(s) detected in connection with block 704. As previously described, the efficiency calculator 202 can advantageously utilize the reference data 614 (e.g., see Eq. (1) above) to provide this calculation based on such parameter(s).

The example method 700 of FIG. 7 also includes modulating, via circuitry of the thruster, the magnetic field to maintain the observed efficiency at a target efficiency of the thruster (block 708). In some examples, the control system 600 of FIG. 6 modulates, via the circuitry 108 of the thruster 102, the magnetic field 114 to maintain the observed thrust efficiency of the thruster 102 at the target thrust efficiency of the thruster 102 (e.g., see FIGS. 3B and 4B). As previously described, the thruster interface 604 can transmit (e.g., continuously or repeatedly) the aforementioned control signal(s) or command(s) and/or electrical power to the circuitry 108 to provide modulation of the magnetic field 114.

The example method 700 of FIG. 7 also includes determining whether to provide additional thrust (block 710). In some examples, the control system 600 of FIG. 6 is configured to determine whether to provide additional thrust to the mass or body associated with the thruster 102. In some examples, if the control system 600 provides a positive determination (block 710: YES), control of the example method 700 of FIG. 7 returns to block 702. Thus, in such examples, blocks 702, 704, 706, 708 of FIG. 7 can be executed repeatedly, which provides a substantially continuous modulation of the magnetic field during the thrust process of the thruster 102. On the other hand, if the control system 600 provides a negative determination (block 710: NO), the example method 700 of FIG. 7 ends.

Although the example method 700 is described in connection with the flowchart of FIG. 7, one or more other methods of implementing the example control system 600 may alternatively be used. For example, the order of execution of the blocks 702, 704, 706, 708, 710 may be changed, and/or at least some operations of the blocks 702, 704, 706, 708, 710 described may be changed, eliminated, or combined.

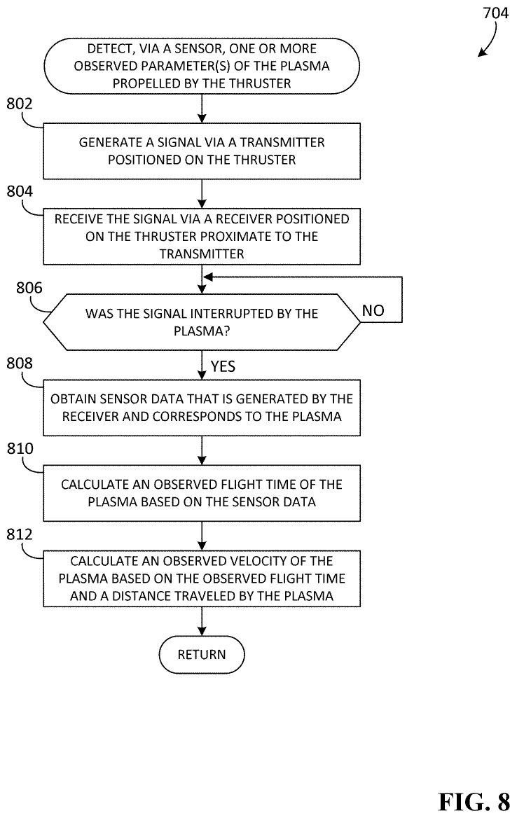

FIG. 8 is a flowchart representative of an example method 704 that may be executed to implement the example control system 600 of FIG. 6 to detect one or more observed parameters of propelled plasma. The example method 704 of FIG. 8 can be implemented in any of the propulsion system 100 of FIG. 1, the thruster 102 of FIGS. 1 and 2, and/or the controller 106 of FIGS. 1, 2, and 6. Example operations of blocks 802, 804, 806, 808, 810, 812 can be used to implement block 704 of FIG. 7.

The example method 704 of FIG. 8 begins by generating a signal via a transmitter positioned on the thruster (block 802). In some examples, the control system 600 of FIG. 6 generates the signal 142 via the transmitter 140.

The example method 704 of FIG. 8 also includes receiving the signal via a receiver positioned on the thruster proximate to the transmitter (block 804). In some examples, the control system 600 of FIG. 6 receives the signal 142 via the receiver 138. The example method 704 of FIG. 8 also includes determining whether the signal was interrupted by the plasma (block 806). In some examples, the control system 600 of FIG. 6 determines (e.g., via the sensor interface 602) whether the signal 142 provided in connection with blocks 802 and 804 was interrupted by the plasma 110. In some examples, if the control system 600 provides a negative determination (block 806: NO), control of the example method 704 of FIG. 8 returns to block 806. That is, in such examples, the control system 600 is configured to wait until the signal 142 is interrupted. On the other hand, if the control system 600 provides a positive determination (block 806: YES), control of the example method 704 of FIG. 8 proceeds to block 808.

The example method 704 of FIG. 8 also includes obtaining sensor data that is generated by the receiver and corresponds to the plasma (block 808). In some examples, the control system 600 of FIG. 6 obtains (e.g., via the sensor interface 602) at least a portion of the sensor data 612 that corresponds to the plasma 110 detected in connection with block 806. For example, the control system 600 obtains the first and second timestamps associated with the signal interruption, as previously described in connection with FIG. 6.

The example method 704 of FIG. 8 also includes calculating an observed flight time of the plasma based on the sensor data (block 810). In some examples, the control system 600 of FIG. 6 calculates (e.g., via the efficiency calculator 202) the observed flight time of the plasma 110 of FIG. 1. For example, the efficiency calculator 202 is configured to calculate the observed flight time of the plasma 110 based on the first and second timestamps obtained in connection with block 808.

The example method 704 of FIG. 8 also includes calculating an observed velocity of the plasma based on the observed flight time and a distance traveled by the plasma (block 812). In some examples, the control system 600 of FIG. 6 calculates (e.g., via the efficiency calculator 202) the observed velocity 146 of the plasma 110 based on the observed flight time calculated in connection with block 810 and the distance 144 travelled by the plasma 110. As previously described, the efficiency calculator 202 can advantageously utilize the reference data 614 (e.g., see Eq. (2) above) to provide such a calculation based on the observed flight time and the distance 144. After performing the operation of block 812, control of the example method 704 of FIG. 8 returns to a calling function such as the example method 700 of FIG. 7.

Although the example method 704 is described in connection with the flowchart of FIG. 8, one or more other methods of implementing the example control system 600 may alternatively be used. For example, the order of execution of the blocks 802, 804, 806, 808, 810, 812 may be changed, and/or at least some operations of the blocks 802, 804, 806, 808, 810, 812 described may be changed, eliminated, or combined. In some examples, the blocks 802, 804, 806, 808, 810, 812 are repeatedly executed during the thrust process of the thruster 102, which can improve feedback control provided by the control system 600. In such examples, as the thruster 102 generates and propels one or more subsequent plasmas during the thrust process, the control system 600 repeatedly or continuously (a) detects such observed parameter(s) of the respective subsequent plasma(s) and (b) calculates observed velocities of the respective subsequent plasma(s).

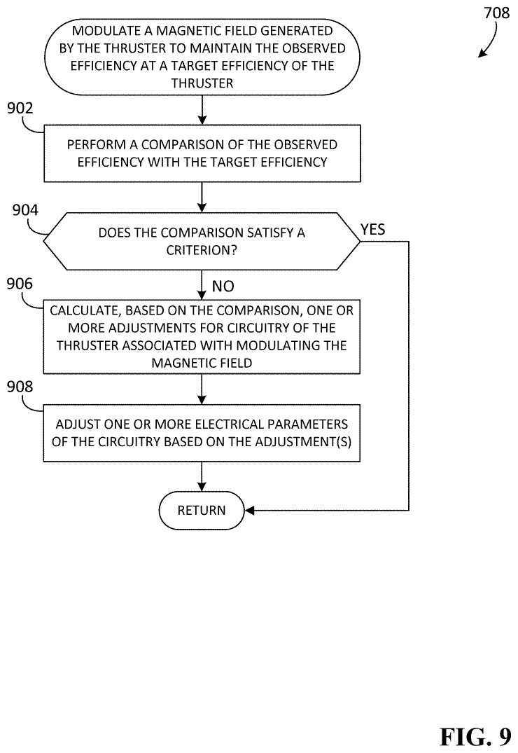

FIG. 9 is a flowchart representative of an example method 708 that may be executed to implement the example control system 600 of FIG. 6 to modulate a magnetic field generated by a thruster to maintain an observed efficiency at a target efficiency. The example method 708 of FIG. 9 can be implemented in any of the propulsion system 100 of FIG. 1, the thruster 102 of FIGS. 1 and 2, and/or the controller 106 of FIGS. 1, 2, and 6. Example operations of blocks 902, 904, 906, 908 can be used to implement block 708 of FIG. 7.

The example method 708 of FIG. 9 begins by performing a comparison of the observed efficiency with the target efficiency (block 902). In some examples, the control system 600 of FIG. 6 performs the first comparison (e.g., via the comparator 204) of the observed thrust efficiency of the thruster 102 with the target thrust efficiency of the thruster 102.

The example method 708 of FIG. 9 also includes determining whether the comparison satisfies a criterion (block 904). In some examples, the control system 600 of FIG. 6 determines (e.g., via the comparator 204) whether the first comparison performed in connection with block 902 satisfies the first criterion of the target parameter data 624. As previously described, the first criterion can include the first threshold value corresponding to the maximum allowable difference between of the observed thrust efficiency of the thruster 102 and the target thrust efficiency of the thruster 102. In some examples, if the control system 600 provides a positive determination (e.g., the observed thrust efficiency is less than the first threshold value) (block 904: YES), control of the example method 708 of FIG. 9 returns to a calling function such as the example method 700 of FIG. 7. On the other hand, if the control system 600 provides a negative determination (e.g., the observed thrust efficiency is greater than or equal to the first threshold value) (block 904: NO), control of the example method 708 of FIG. 9 proceeds to the block 906.

The example method 708 of FIG. 9 also includes calculating, based on the comparison, one or more adjustments for circuitry of the thruster associated with modulating the magnetic field (block 906). In some examples, the control system 600 of FIG. 6 calculates (e.g., via the field modulator 206), based on the first comparison performed in connection with block 904, the adjustment(s) for the circuitry 108 of the thruster 102 associated with modulating the magnetic field 114.

The example method 708 of FIG. 9 also includes adjusting one or more electrical parameters of the circuitry based on the adjustment(s) (block 908). In some examples, the control system 600 of FIG. 6 adjusts (e.g., via the thruster interface 604) the electrical parameter(s) of the circuitry 108 based on the adjustment(s) calculated in connection with block 906. As previously described, the control system 600 can change the input voltage applied to the first circuit component 132 when the first circuit component 132 is charging for a pulse of the thruster 102. Additionally or alternatively, the control system 600 can change the strength of the electric current 124 when the first circuit component 132 is discharging during the pulse.

Although the example method 708 is described in connection with the flowchart of FIG. 9, one or more other methods of implementing the example control system 600 may alternatively be used. For example, the order of execution of the blocks 902, 904, 906, 908 may be changed, and/or at least some operations of the blocks 902, 904, 906, 908 described may be changed, eliminated, or combined.

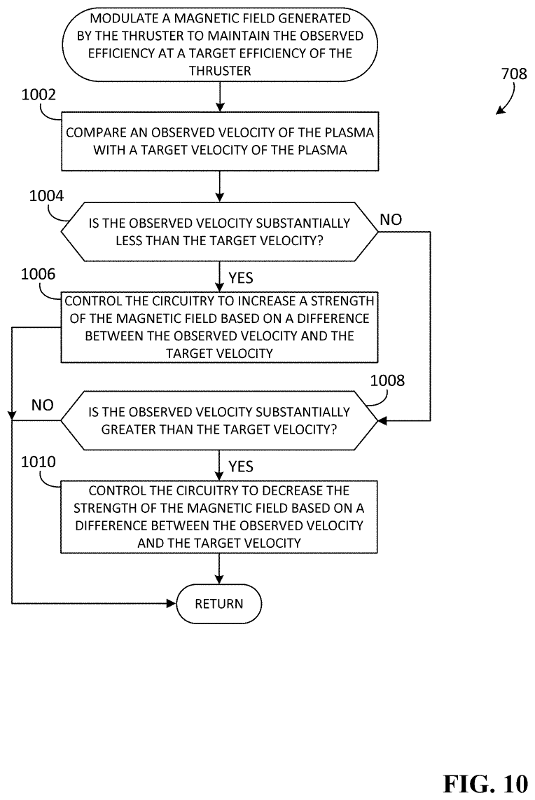

FIG. 10 is a flowchart representative of an example method 708 that may be executed to implement the example control system 600 of FIG. 6 to modulate a magnetic field generated by a thruster to maintain an observed efficiency at a target efficiency. The example method 708 of FIG. 9 can be implemented in any of the propulsion system 100 of FIG. 1, the thruster 102 of FIGS. 1 and 2, and/or the controller 106 of FIGS. 1, 2, and 6. Example operations of blocks 1002, 1004, 1006, 1008, 1010 can be used to implement block 708 of FIG. 7.

The example method 708 of FIG. 10 begins by comparing an observed velocity of the plasma with a target velocity of the plasma (block 1002). In some examples, the control system 600 of FIG. 6 compares (e.g., via the comparator 204) the observed velocity 146 of the plasma 110 with the target velocity of the plasma 110. As previously described, the comparator 204 can perform the second comparison.

The example method 708 of FIG. 10 also includes determining whether the observed velocity 146 is substantially less than the target velocity (block 1004). In some examples, the control system 600 of FIG. 6 determines (e.g., via the comparator 204) whether the observed velocity 146 of the plasma 110 is substantially less than the target velocity of the plasma 110. For example, the control system 600 determines whether the second comparison performed in connection with block 1002 satisfies the second criterion of the target parameter data 624. As previously described, the second criterion can include the lower threshold value corresponding to the minimum allowable velocity of the plasma 110. In particular, if the control system 600 provides a positive determination (e.g., the observed velocity 146 is less than or equal to the lower threshold value) (block 1004: YES), control of the example method 708 of FIG. 10 proceeds to block 1006. On the other hand, if the control system 600 provides a negative determination (e.g., the observed velocity 146 is greater than the lower threshold value) (block 1004: NO), control of the example method 708 of FIG. 10 proceeds to the block 1008.

The example method 708 of FIG. 10 also includes controlling the circuitry to increase a strength of the magnetic field based on a difference between the observed velocity and the target velocity (block 1006). In some examples, the control system 600 of FIG. 6 controls (e.g., via the thruster interface 604) the circuitry 108 to increase the strength of the magnetic field 114 based on the second error value previously described. After performing the operation of block 1006, control of the example method 708 of FIG. 10 returns to a calling function such as the example method 700 of FIG. 7.

The example method 708 of FIG. 10 also includes determining whether the observed velocity is substantially greater than the target velocity (block 1008). In some examples, the control system 600 of FIG. 6 determines (e.g., via the comparator 204) whether the observed velocity 146 of the plasma 110 is substantially greater than the target velocity of the plasma 110. For example, the control system 600 determines whether the second comparison performed in connection with block 1002 satisfies the third criterion of the target parameter data 624. As previously described, the third criterion can include the upper threshold value corresponding to the maximum allowable velocity of the plasma 110. In particular, if the control system 600 provides a positive determination (e.g., the observed velocity 146 is greater than or equal to the upper threshold value) (block 1008: YES), control of the example method 708 of FIG. 10 proceeds to block 1010. On the other hand, if the control system 600 provides a negative determination (e.g., the observed velocity 146 is less than the upper threshold value) (block 1008: NO), control of the example method 708 of FIG. 10 returns to a calling function such as the example method 700 of FIG. 7.

The example method 708 of FIG. 10 also includes controlling the circuitry to decrease the strength of the magnetic field based on a difference between the observed velocity and the target velocity (block 1010). In some examples, the control system 600 of FIG. 6 controls (e.g., via the thruster interface 604) the circuitry 108 to decrease the strength of the magnetic field 114 based on the second error value previously described. After performing the operation of block 1010, control of the example method 708 of FIG. 10 returns to a calling function such as the example method 700 of FIG. 7.

Although the example method 708 is described in connection with the flowchart of FIG. 10, one or more other methods of implementing the example control system 600 may alternatively be used. For example, the order of execution of the blocks 1002, 1004, 1006, 1008, 1010 may be changed, and/or at least some operations of the blocks 1002, 1004, 1006, 1008, 1010 described may be changed, eliminated, or combined.

FIG. 11 is a block diagram of an example processor platform 1100 structured to execute instructions to carry out the methods of FIGS. 7-10 and/or, more generally, to implement the control system 600 of FIG. 6. For example, the processor platform 1100 can be a personal computer, a server, a mobile device (e.g., a cell phone, a smart phone, a tablet, etc.) or any other type of computing device. According to the illustrated example of FIG. 11, the processor platform 1100 includes a central processing unit (CPU) 1102 (sometimes referred to as a processor), which is hardware (e.g., one or more integrated circuits, logic circuits, microprocessors, etc.). The CPU 1102 of FIG. 11 includes a local memory 1104 such as, for example, a cache. In some examples, the CPU 1102 of FIG. 11 corresponds to the primary processor 148 of FIG. 1. In the example of FIG. 11, the CPU 1102 implements the example efficiency calculator 202, the example comparator 204, the example field modulator 206, the example sensor interface 602, the example thruster interface 604, and the example network interface 606.

Coded instruction(s) 1106 to implement the methods of FIGS. 7-10 may be stored in a main memory 1108 of the processor platform 1100. The memory 1108 may include a volatile memory (e.g., random access memory device(s) such as Dynamic Random Access Memory (DRAM)) and a non-volatile memory (e.g., flash memory). In the example of FIG. 11, the main memory 1108 implements the example database 208. Such processes and/or instructions may also be stored on a storage medium disk 1110 associated with the processor platform 1100, such as a hard drive (HDD) or portable storage medium, or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the processor platform 1100 communicates, such as a server or computer for example.

Further, the claimed advancements may be provided as a utility application, background daemon, or component of an operating system, or combination thereof, executing in conjunction with the CPU 1102 and an operating system such as, for example, Microsoft Windows 7, Microsoft Windows 10, UNIX, Solaris, LINUX, Apple MAC-OS or any other system(s) known to those skilled in the art.

The hardware elements in order to achieve the processor platform 1100 may be realized by various circuitry elements, known to those skilled in the art. For example, the CPU 1102 may be a Xenon or Core processor from Intel of America or an Opteron processor from AMD of America, or may be other processor types that would be recognized by one of ordinary skill in the art. Alternatively, the CPU 1102 may be implemented on an FPGA, ASIC, PLD or using discrete logic circuits, as one of ordinary skill in the art would recognize. Further, the CPU 1102 may be implemented as multiple processors cooperatively working in parallel to perform the instructions of the inventive processes described above.

In some examples, the processor platform 1100 of FIG. 11 also includes a network controller 1112 such as, for example, an Intel Ethernet PRO network interface card from Intel Corporation of America for interfacing with one or more networks 1114. As can be appreciated, the network(s) 1114 can be one or more public networks (e.g., the Internet), private networks (e.g., a LAN, a WAN, etc.) and/or sub-networks (e.g., a public switched telephone network (PSTN), an integrated services digital network (ISDN), etc.). The network(s) 1114 can also be wired, such as an Ethernet network, or can be wireless such as a cellular network including EDGE, 3G and 4G wireless cellular systems. The wireless network can also be WiFi, Bluetooth, or any other wireless form of communication that is known.

The processor platform 1100 of FIG. 11 includes a general purpose I/O interface circuit 1116 that interfaces and/or otherwise communicates with one or more input devices 1118 and/or one or more output devices 1120. The I/O interface circuit 1116 of FIG. 11 may be implemented as an Ethernet interface, a universal serial bus (USB), a PCI express interface, and/or any other type of standard interface.

The input devices 1118 are connected to the I/O interface circuit 1116 and may include, for example, a keyboard, a mouse, a touchscreen, a button, a microphone, a voice recognition system, a camera, and/or any other suitable device(s) for enabling a user to input data and/or commands to the CPU 1102.

The output device(s) 1120 are also connected to the I/O interface circuit 1116 and may include display devices such as, for example, a light-emitting diode (LED), a liquid crystal display, a touchscreen, a printer, a scanner (e.g., an OfficeJet or DeskJet from Hewlett Packard), a speaker, and/or any other device(s) for providing or presenting information (e.g., visual information and/or audible information) to a user. As such, in some examples, the I/O interface circuit 1116 includes a display controller 1122 such as, for example, a NVIDIA GeForce GTX or Quadro graphics adaptor from NVIDIA Corporation of America for interfacing with a display (e.g., a Hewlett Packard HPL2445w LCD monitor). Additionally, in some examples, the I/O interface circuit includes a sound controller 1124 such as, for example, Sound Blaster X-Fi Titanium from Creative, to interface with a speaker and/or a microphone.

The processor platform 1100 of FIG. 11 also includes a general purpose storage controller 1126 that connects the storage medium disk 1110 with a communication bus 1128. The storage controller 1126 may also control access to the memory 1108. The communication bus 1128 of FIG. 11 may be an ISA, EISA, VESA, PCI, etc. for interconnecting all of the components of the processor platform 1100. For example, the CPU 1102 communicates with the main memory 1108 via the bus 1128.

It will be appreciated that the control systems, apparatus, methods for use with thrusters disclosed in the foregoing description provide numerous advantages. Examples disclosed herein provide an efficient, low mass, and low cost propulsion solution. Examples disclosed herein rapidly compensate and/or correct one or more undesired operating parameters of a thruster, thereby improving efficiency as well as velocity of the thruster and, consequently, the impulse.

Although certain example systems, apparatus, methods, and articles of manufacture have been disclosed herein, the scope of coverage of this patent is not limited thereto. Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

What is claimed is:

1. A propulsion system, comprising:
a pulsed plasma thruster (PPT) including circuitry, an anode, a cathode, and a propellant arranged between the anode and the cathode, the circuitry configured to generate (a) plasma from the propellant via an ignition member of the PPT and (b) a magnetic field, via the anode and the cathode, that propels the plasma away from the PPT in an expulsion direction, the circuitry including a capacitor configured to store electrical energy for a pulse of the PPT and discharge the electrical energy during the pulse;
a sensor including a laser receiver and a laser transmitter that are positioned on the PPT, the laser receiver configured to receive a signal from the laser transmitter; and
a controller connected to the circuitry and the sensor,
wherein, in response to the plasma interrupting the signal, the controller is configured to:
detect an observed parameter of the plasma via the sensor,
calculate an observed thrust efficiency of the PPT based on the observed parameter, and
modulate, via the circuitry, the magnetic field to maintain the observed thrust efficiency at a target thrust efficiency of the PPT.

2. The propulsion system of claim 1, wherein the controller includes a feedback controller forming a feedback control loop with the PPT and the sensor.

3. The propulsion system of claim 1, wherein the controller is configured to:
perform a comparison of the observed thrust efficiency with the target thrust efficiency,
calculate, based on the comparison, an adjustment for the circuitry associated with modulating the magnetic field, and
adjust an electrical parameter of the circuitry based on the adjustment.

4. The propulsion system of claim 1, wherein the anode and cathode define an exhaust port of the PPT from which the plasma is expellable, the laser receiver and the laser transmitter positioned proximate to the exhaust port such that the signal intersects a trajectory of the plasma.

5. The propulsion system of claim 1, wherein the controller is configured to:
calculate an observed flight time of the plasma based on sensor data generated by the laser receiver;
calculate an observed velocity of the plasma based on the observed flight time of the plasma and a distance traveled by the plasma, and
calculate the observed thrust efficiency of the PPT based on the observed velocity.

6. The propulsion system of claim 1, wherein the observed parameter includes an observed velocity of the plasma.

7. The propulsion system of claim 6, wherein the controller is configured to control the circuitry to increase a strength of the magnetic field when the observed velocity of the plasma is less than a target velocity of the plasma.

8. The propulsion system of claim 6, wherein the controller is configured to control the circuitry to decrease a strength of the magnetic field when the observed velocity of the plasma is greater than a target velocity of the plasma.

9. An apparatus for a thruster, comprising:
a sensor positioned on the thruster proximate to an exhaust port of the thruster; and
a controller operatively coupled to the thruster and configured to:
detect an observed parameter of a plasma generated by the thruster via the sensor, the plasma to be expelled from the exhaust port,
calculate an observed thrust efficiency of the thruster based on the observed parameter, and
modulate, via circuitry of the thruster, a magnetic field propelling the plasma away from the thruster in an expulsion direction to maintain the observed thrust efficiency at a target thrust efficiency of the thruster.

10. The apparatus of claim 9, wherein the controller includes a feedback controller forming a feedback control loop with the thruster and the sensor.

11. The apparatus of claim 9, wherein the controller is configured to:
perform a comparison of the observed thrust efficiency with the target thrust efficiency,
calculate, based on the comparison, an adjustment for the circuitry associated with modulating the magnetic field, and
adjust an electrical parameter of the circuitry based on the adjustment.

12. The apparatus of claim 9, wherein the sensor includes a receiver and a transmitter that are spaced apart from each other by an angle relative to an axis of the exhaust port, the receiver configured to receive a signal from the transmitter, the controller configured to control the circuitry to modulate the magnetic field in response to the plasma interrupting the signal.

13. The apparatus of claim 12, wherein the controller is configured to:
calculate an observed flight time of the plasma based on sensor data generated by the receiver;
calculate an observed velocity of the plasma based on the observed flight time of the plasma and a distance traveled by the plasma, and
calculate the observed thrust efficiency of the thruster based on the observed velocity.

14. The apparatus of claim 12, wherein the receiver is a laser receiver and the transmitter is a laser transmitter.

15. The apparatus of claim 9, wherein the observed parameter includes an observed velocity of the plasma.

16. The apparatus of claim 15, wherein the controller is configured to control the circuitry to increase a strength of the magnetic field when the observed velocity of the plasma is less than a target velocity of the plasma.

17. The apparatus of claim 15, wherein the controller is configured to control the circuitry to decrease a strength of the magnetic field when the observed velocity of the plasma is greater than a target velocity of the plasma.

18. A computer-implemented method of providing thrust, comprising:
controlling circuitry of a thruster to generate (a) plasma from a propellant via an ignition member and (b) a magnetic field, via an anode and a cathode, that propels the plasma away from the thruster in an expulsion direction;
detecting an observed parameter of the plasma via a sensor of the thruster positioned proximate to an exhaust port;
calculating an observed thrust efficiency of the thruster based on the observed parameter; and
modulating, via the circuitry, the magnetic field to maintain the observed thrust efficiency at a target thrust efficiency of the thruster.

19. The computer-implemented method of claim 18, further including:
performing a comparison of the observed thrust efficiency with the target thrust efficiency,
calculating, based on the comparison, an adjustment for the circuitry associated with modulating the magnetic field, and
adjusting an electrical parameter of the circuitry based on the adjustment.
